(19) United States
(12) Patent Application Publication
(10) Pub. No.: US 2025/0026936 A1
(43) Pub. Date: Jan. 23, 2025

(54) COMPOUND, COMPOSITION, SURFACE TREATMENT AGENT, ARTICLE, AND METHOD OF PRODUCING ARTICLE

(71) Applicant: AGC Inc., Tokyo (JP)

(72) Inventors: Koki WATANABE, Tokyo (JP); Motoshi AOYAMA, Tokyo (JP)

(73) Assignee: AGC Inc., Tokyo (JP)

(21) Appl. No.: 18/894,080

(22) Filed: Sep. 24, 2024

Related U.S. Application Data
(63) Continuation of application No. PCT/JP2023/008163, filed on Mar. 3, 2023.

(30) Foreign Application Priority Data
Mar. 24, 2022 (JP) 2022-049061

(51) Int. Cl. C09D 5/16; C07F 7/21; C08G 77/18; C09D 183/08; G02B 1/04

(52) U.S. Cl. CPC C09D 5/1675; C07F 7/21; C08G 77/18; C09D 183/08; G02B 1/04

(57) ABSTRACT

A compound including the following Group 1, a partial structure that is an alkylene chain, a polyalkylene oxide chain, a divalent organopolysiloxane residue, or a combination thereof, and the following Group 2. Group 1: monovalent cyclic polysiloxane residue or monovalent cage-like polysiloxane residue Group 2: —Si(R²)ₙL₃₋ₙ R² is a monovalent hydrocarbon group, each of pieces of L is independently a hydrolyzable group or a hydroxyl group, and n is an integer from 0 to 2.

### CROSS-REFERENCE TO RELATED APPLICATION

This application is a Continuation of International Application No. PCT/JP2023/008163, filed Mar. 3, 2023, which claims priority to Japanese Patent Application No. 2022-049061 filed Mar. 24, 2022. Each of the above applications is hereby expressly incorporated by reference, in its entirety, into the present application.

### TECHNICAL FIELD

The present disclosure relates to a compound, a composition, a surface treatment agent, an article, and a method of producing an article.

### BACKGROUND ART

In recent years, in order to improve performance such as appearance and visibility, a technique for making it difficult for a fingerprint to adhere to a surface of an article and a technique for making it easy to remove stains are required. As a specific method, a method of performing a surface treatment on a surface of an article using a surface treatment agent is known.

For example, Patent Literature 1 describes a composition containing an organosilicon compound having at least one trialkylsilyl group and two or more hydrolyzable silicon groups, and a metal compound in which at least one hydrolyzable group is bonded to a metal atom. Patent Literature 2 describes a method of producing an organic thin film in which an organic thin film is formed on a surface of a substrate, the method including at least a step of bringing the substrate into contact with an organic solvent solution containing a metal-based surfactant having at least one hydrolyzable group or hydroxyl group and a catalyst capable of interacting with the metal-based surfactant.

### CITATION LIST

### Patent Literature

Patent Literature 1: Japanese Patent Application Laid-Open (JP-A) No. 2017-119849
Patent Literature 2: WO 2008/016029 A

### SUMMARY OF INVENTION

### Technical Problem

Compositions used for surface treatment agents and the like are required to be further improved from the viewpoint of water repellency and abrasion resistance.

The present disclosure has been made in view of such circumstances, and an object of an embodiment of the present invention is to provide a novel compound and composition useful as a surface treatment agent capable of forming a surface treatment layer excellent in water repellency and abrasion resistance on a substrate.

An object of an embodiment of the present invention is to provide a surface treatment agent capable of forming a surface treatment layer excellent in water repellency and abrasion resistance on a substrate.

An object of an embodiment of the present invention is to provide an article having a surface treatment layer excellent in water repellency and abrasion resistance, and a method of producing the article.

### Solution to Problem

The present disclosure includes the following aspects.

<1>

A compound comprising the following Group 1, a partial structure that is an alkylene chain, a polyalkylene oxide chain, a divalent organopolysiloxane residue, or a combination thereof, and the following Group 2.
Group 1: monovalent cyclic polysiloxane residue or monovalent cage-like polysiloxane residue
Group 2: —Si(R²)ₙL₃₋ₙ
R² is a monovalent hydrocarbon group, each L is independently a hydrolyzable group or a hydroxyl group, and n is an integer from 0 to 2.
   <2>

The compound according to <1>, represented by the following Formula 1:

[T-(O)ᵣ—Z]_{q}A(Si(R²)ₙL₃₋ₙ)ₚ (1)

In Formula 1, T represents a monovalent cyclic polysiloxane residue or a monovalent cage-like polysiloxane residue, r represents 0 or 1, Z represents an alkylene chain, a polyalkylene oxide chain, a divalent organopolysiloxane residue, or a combination thereof, A represents a single bond or a (p+q)-valent linking group, each of R² independently represents a monovalent hydrocarbon group, each L independently represents a hydrolyzable group or a hydroxyl group, n represents an integer from 0 to 2, and each of p and q independently represent an integer of 1 or more.
<3>

The compound according to <2>, wherein Z is an alkylene chain having 12 or more carbon atoms in Formula 1.

<4>

The compound according to <2>, wherein in Formula 1, Z is represented by —Z¹—Z²—Z³—, each of Z¹ and Z³ is independently an alkylene chain, and Z² is a divalent organopolysiloxane residue.

<5>

The compound according to any one of <2> to <4>, wherein in Formula 1, T is represented by the following Formula T1.

In Formula T1, each R³ independently represents a hydrocarbon group, a hydrocarbon group having a substituent, or a group represented by —O—SiR⁵¹₃, s represents an integer from 1 to 4, and each R⁵¹ independently represents a hydrocarbon group or a trialkylsilyloxy group.

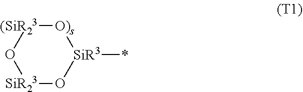

<6>

The compound according to <5>, wherein in Formula T1, each R³ independently represents an alkyl group having 1 to 4 carbon atoms.

<7>

A composition including the compound according to any one of <1> to <6> and a liquid medium.

<8>

A surface treatment agent including the compound according to any one of <1> to <6>.

<9>

A surface treatment agent including the compound according to any one of <1> to <6> and a liquid medium.

<10>

A method of producing an article, the method comprising: subjecting a substrate to a surface treatment with the surface treatment agent according to <8> or <9> to produce an article having a surface treatment layer formed on the substrate.

<11>

An article including: a substrate; and a surface treatment layer disposed on the substrate and surface-treated with the surface treatment agent according to <8>.

<12>

The article according to <11>, the article being an optical member.

<13>

The article according to <11> or <12>, the article being a display or a touch panel.

### Advantageous Effects of Invention

An embodiment of the present invention provides a novel compound and composition useful as a surface treatment agent capable of forming a surface treatment layer excellent in water repellency and abrasion resistance on a substrate.

An embodiment of the present invention provides a surface treatment agent capable of forming a surface treatment layer excellent in water repellency and abrasion resistance on a substrate.

An embodiment of the present invention provides an article having a surface treatment layer excellent in water repellency and abrasion resistance and a method of producing the article.

### DESCRIPTION OF EMBODIMENTS

In the present description, the numerical range indicated using “to” includes the numerical values described before and after “to” as the minimum value and the maximum value, respectively.

In the numerical ranges described in stages in the present description, the upper limit value or the lower limit value described in one numerical range may be replaced with the upper limit value or the lower limit value of the numerical range described in another stage. In addition, in the numerical range described in the present description, the upper limit value or the lower limit value of the numerical range may be replaced with a value shown in Examples.

In the present description, the “surface treatment layer” means a layer formed on the surface of the substrate by surface treatment.

In the present description, in a case in which a compound or group is represented by a specific Formula (X), the compound or group represented by Formula (X) may be referred to as a Compound (X) or a Compound X, and a Group (X) or a Group X, respectively.

### [Compound]

A compound according to the present disclosure comprises the following Group 1, a partial structure that is an alkylene chain, a polyalkylene oxide chain, a divalent organopolysiloxane residue, or a combination thereof, and the following Group 2.
Group 1: monovalent cyclic polysiloxane residue or monovalent cage-like polysiloxane residue
Group 2: —Si(R²)ₙL₃₋ₙ
R² is a monovalent hydrocarbon group, each L is independently a hydrolyzable group or a hydroxyl group, and n is an integer from 0 to 2.

When the compound of the disclosure is used as a surface treatment agent, a surface treatment agent excellent in water repellency and abrasion resistance can be formed. The reason for this is not clear, but is presumed as follows.

In the compound of the present disclosure, the Group 2 is contained, and thus adhesion to the substrate is high, and the surface treatment layer can be formed on the substrate. In addition, containing the Group 1 can impart water repellency. In addition, containing the Group 1 disposes partial structures that are an alkylene chain, a polyalkylene oxide chain, a divalent organopolysiloxane residue, or a combination thereof in line, whereby intermolecular interaction works to form a packing structure, and thus abrasion resistance can be imparted.

The compound described in Patent Literature 1 has a divalent organopolysiloxane residue, but does not contain the Group 1, and thus it is considered that the abrasion resistance of the surface treatment layer is insufficient in a case of being used as a surface treatment agent. The compound described in Patent Literature 2 has the alkylene chain, but does not contain the Group 1, and thus it is considered that the water repellency of the surface treatment layer is insufficient in a case of being used as a surface treatment agent.

Hereinafter, the compound of the disclosure will be described in detail.

### (Group 1)

The compound of the present disclosure includes the above Group 1. In the compound, only one Group 1 may be contained, or two or more Groups 1 may be contained. The Group 1 is a monovalent group, and thus is located at the terminal of the compound.
Group 1: monovalent cyclic polysiloxane residue or monovalent cage-like polysiloxane residue

In a case in which there are a plurality of Groups 1 in one molecule, the plurality of Groups 1 may be the same or different from each other. From the viewpoint of availability of raw materials and ease of production of the compound, the plurality of Groups 1 are preferably the same.

The Group 1 is bulky, and thus the number of Groups 1 is preferably one from the viewpoint of ease of production of the compound.

The monovalent cyclic polysiloxane residue is preferably a group represented by the following Formula T1.

In Formula T1, each R³ independently represents a hydrocarbon group, a hydrocarbon group having a substituent, or a group represented by —O—SiR⁵¹₃, and s represents an integer from 1 to 4. Each R⁵¹ independently represents a hydrocarbon group or a trialkylsilyloxy group.

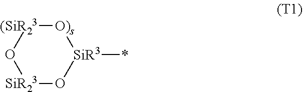

Examples of the hydrocarbon group represented by R³ include an aliphatic hydrocarbon group and an aromatic hydrocarbon group. Among them, the hydrocarbon group is preferably an aliphatic hydrocarbon group, and more preferably an alkyl group.

The alkyl group may be any of a linear alkyl group, a branched alkyl group, and a cycloalkyl group, and is preferably a linear alkyl group. The number of carbon atoms in the alkyl group is preferably from 1 to 10, more preferably from 1 to 8, and still more preferably from 1 to 4. Specifically, the alkyl group represented by R³ is preferably a methyl group, an ethyl group, a n-propyl group, a n-butyl group, an isobutyl group, or a heptyl group, and more preferably a methyl group.

Examples of the hydrocarbon group contained in the hydrocarbon group having a substituent represented by R³ include an aliphatic hydrocarbon group and an aromatic hydrocarbon group. Among them, the hydrocarbon group is preferably an aliphatic hydrocarbon group, and more preferably an alkyl group. The alkyl group may be any of a linear alkyl group, a branched alkyl group, and a cycloalkyl group, and is preferably a linear alkyl group. The number of carbon atoms of the alkyl group contained in the substituted alkyl group is preferably from 1 to 10, more preferably from 1 to 8, and still more preferably from 2 to 4.

Examples of the substituent in the hydrocarbon group having a substituent represented by R³ include a halogen atom, a hydroxyl group, an alkoxy group, a trialkylsilyl ether group, a trialkylsilyl group, an amino group, a nitro group, a cyano group, a sulfonyl group, a trifluoromethyl group, and a group represented by —SiR⁵²3. Each of R¹² independently represents a hydrocarbon group or a trialkylsilyloxy group.

Examples of the hydrocarbon group represented by R⁵² include the same groups as the hydrocarbon group represented by R³.

The alkyl group contained in the trialkylsilyloxy group represented by R¹² may be any of a linear alkyl group, a branched alkyl group, and a cycloalkyl group, but is preferably a linear alkyl group. The number of carbon atoms in the alkyl group is preferably from 1 to 10, more preferably from 1 to 8, still more preferably from 1 to 4, and particularly preferably 1. The three alkyl groups contained in the trialkylsilyloxy group may be the same or different from each other.

The three pieces of R⁵²s may be the same or different from each other, but are preferably the same from the viewpoint of ease of production.

In the group represented by —O—SiR⁵¹₃ represented by R³, each R¹ independently represents a hydrocarbon group or a trialkylsilyloxy group. Examples of the hydrocarbon group represented by R⁵¹ include the same groups as the hydrocarbon group represented by R³. Examples of the trialkylsilyloxy group represented by R¹ include the same groups as the trialkylsilyloxy group represented by R⁵².

The plurality of R³s may be the same or different from each other, but are preferably the same from the viewpoint of ease of production.

Examples of the monovalent cyclic polysiloxane residue include the following groups.

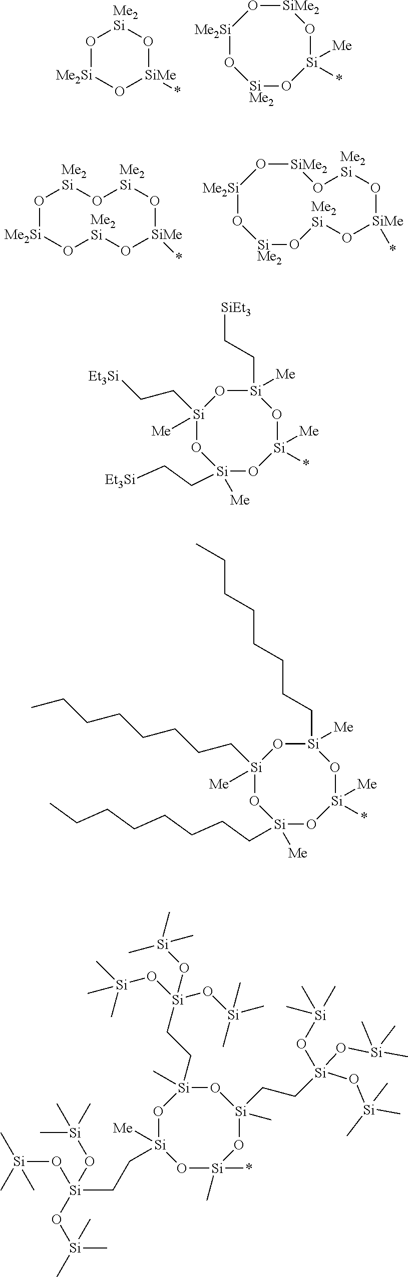

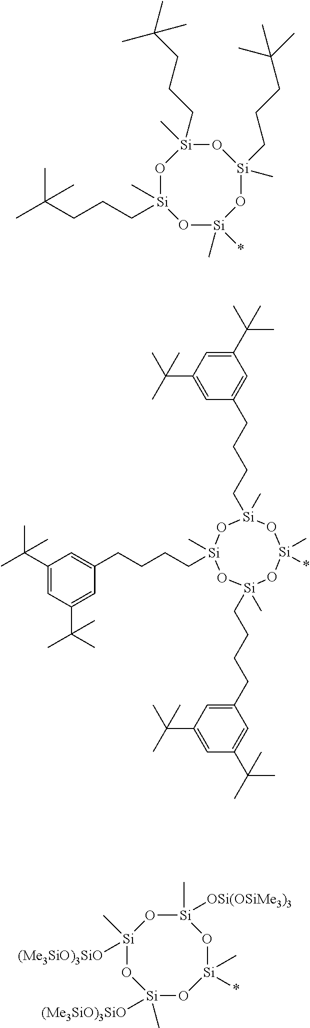

The monovalent cage-like polysiloxane residue is preferably a group represented by the following Formula T2.

In Formula T2, each R⁴ independently represents a hydrocarbon group or a trialkylsilyloxy group.

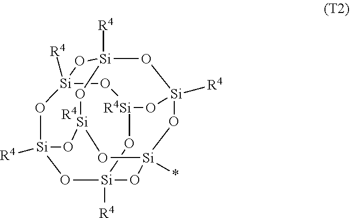

Examples of the hydrocarbon group represented by R⁴ include an aliphatic hydrocarbon group and an aromatic hydrocarbon group. Among them, the hydrocarbon group is preferably an aliphatic hydrocarbon group, and more preferably an alkyl group. The alkyl group may be any of a linear alkyl group, a branched alkyl group, and a cycloalkyl group, but is preferably a linear alkyl group or a branched alkyl group, more preferably a methyl group, an ethyl group, a n-propyl group, a n-butyl group, or an isobutyl group, and still more preferably an isobutyl group.

The alkyl group contained in the trialkylsilyloxy group represented by R⁴ may be any of a linear alkyl group, a branched alkyl group, and a cycloalkyl group, but is preferably a linear alkyl group, more preferably a methyl group, an ethyl group, a n-propyl group, or a n-butyl group, and still more preferably a methyl group. In a case in which R⁴ is a trialkylsilyloxy group, the three alkylsilyloxy groups may be the same or different from each other, but are preferably the same from the viewpoint of ease of production.

Examples of the monovalent cage-like polysiloxane residue include the following group.

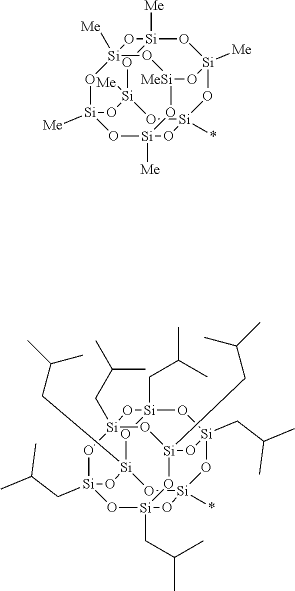

### (Group 2)

The compound of the present disclosure includes the above Group 2. The compound may contain only one Group 2 or two or more Groups 2. For example, the number may be from 1 to 18, from 2 to 12, or from 2 to 8. The Group 2 is a monovalent group, and thus is located at the terminal of the compound.
Group 2: —Si(R²)ₙL₃₋ₙ

Each R² independently represents a hydrocarbon group, each L independently represents a hydrolyzable group or a hydroxyl group, and n represents an integer from 0 to 2.

In a case in which there are a plurality of Groups 2 in one molecule, the plurality of Groups 2 may be the same or different from each other. From the viewpoint of availability of raw materials and ease of production of the compound, the plurality of Groups 2 are preferably the same.

R² is a hydrocarbon group, and is preferably a saturated hydrocarbon group. The number of carbon atoms in R² is preferably from 1 to 6, more preferably from 1 to 3, and still more preferably from 1 to 2.

Each L independently represents a hydrolyzable group or a hydroxyl group.

The hydrolyzable group is a group that becomes a hydroxyl group by a hydrolysis reaction. That is, the hydrolyzable silyl group represented by Si-L undergoes a hydrolysis reaction to become a silanol group represented by Si—OH. The silanol group further react between the silanol groups to form a Si—O—Si bond. The silanol group undergoes dehydration condensation reaction with a silanol group derived from an oxide present on the surface of the substrate to allow forming a Si—O—Si bond.

Examples of the hydrolyzable group include an alkoxy group, an aryloxy group, a halogen atom, an acyl group, an acyloxy group, and an isocyanato group (—NCO). The alkoxy group is preferably an alkoxy group having 1 to 4 carbon atoms. The aryloxy group is preferably an aryloxy group having 3 to 10 carbon atoms. However, examples of the aryl group of the aryloxy group includes a heteroaryl group. The halogen atom is preferably a chlorine atom. The acyl group is preferably an acyl group having 1 to 6 carbon atoms. The acyloxy group is preferably an acyloxy group having 1 to 6 carbon atoms.

Among them, L is preferably an alkoxy group having 1 to 4 carbon atoms or a halogen atom from the viewpoint of ease of production of the compound. L is preferably an alkoxy group having 1 to 4 carbon atoms, and more preferably an ethoxy group or a methoxy group from the viewpoint of less outgassing at the time of coating and more excellent storage stability of the compound.

n is an integer from 0 to 2, preferably 0 or 1, and more preferably 0. The presence of a plurality of L causes stronger adhesion of the surface treatment layer to a substrate.

When n is 1 or less, a plurality of L present in one molecule may be the same or different from each other. The plurality of L is preferably the same from the viewpoint of easy availability of the raw material and easy production of the compound. In a case in which n is 2, a plurality of R²s present in one molecule may be the same or different from each other. The plurality of R²s is preferably the same from the viewpoint of easy availability of the raw material and easy production of the compound.

(Partial Structure that is an Alkylene Chain, a Polyalkylene Oxide Chain, a Divalent Organopolysiloxane Residue, or a Combination Thereof)

The compound of the present disclosure include a partial structure that is an alkylene chain, polyalkylene oxide chain, divalent organopolysiloxane residue, or a combination thereof. The partial structure is preferably present between the Groups 1 and 2. The Group 1 and the partial structure and the Group 2 and the partial structure may be bonded directly or via another structure.

The combination of an alkylene chain, a polyalkylene oxide chain, and a divalent organopolysiloxane residue is preferably a combination of an alkylene chain and a divalent organopolysiloxane residue.

The number of carbon atoms in the alkylene chain is preferably 6 or more, more preferably 10 or more, still more preferably 12 or more, particularly preferably 15 or more from the viewpoint of improving the water repellency and abrasion resistance of the surface treatment layer. The upper limit of the number of carbon atoms in the alkylene chain is not particularly limited, and is, for example, 30.

The alkylene chain may be linear, branched, or cyclic.

Among them, the alkylene chain is preferably linear from the viewpoint of improving the water repellency and abrasion resistance of the surface treatment layer.

The polyalkylene oxide chain is represented by the following Formula A.

(XO)ₘ (A)

In Formula A, each of X independently represents an alkylene group.

The number of carbon atoms in the alkylene group is preferably from 1 to 6, and more preferably from 2 to 4 from the viewpoint of improving the water repellency and abrasion resistance of the surface treatment layer.

The alkylene group may be linear, branched, or cyclic.

Specific examples of (XO) include —CH₂O—, —C₂H₄O—, —C₃H₆O—, —C₄H₈O—, —C₅H₁₀O—, —C₆H₁₂O—, —CH(CH₃)CH₂O—, —CH(CH₃) CH₂CH₂O—, -cycloC₄H₆—O—, -cycloC₅H₈—O—, and -cycloC₆H₁₀—O—.

Herein, -cycloC₄H₆— means a cyclobutanediyl group. Examples of the cyclobutanediyl group include a cyclobutane-1,2-diyl group and a cyclobutane -1,3-diyl group. -cycloC₅H₈— means a cyclopentanediyl group. Examples of the cyclopentanediyl group include a cyclopentane-1,2-diyl group and a cyclopentane-1,3-diyl group. -cycloC₆H₁₀— means a cyclohexanediyl group. Examples of the cyclohexanediyl group include a cyclohexane-1,2-diyl group, a cyclohexane-1,3-diyl group, and a cyclohexane-1,4-diyl group.

The repetition number m of (XO) is an integer of 2 or more, more preferably an integer from 2 to 200, still more preferably an integer from 5 to 150, particularly preferably an integer from 5 to 100, and most preferably an integer from 10 to 50.

(XO)ₘ may include two or more kinds of (XO).

The bonding order of the two or more kinds of (XO) is not limited, and the two or more kinds of (XO) may be disposed in any of random, alternate, and block.

Containing two or more kinds of (XO) is that two or more kinds of (XO) having different carbon numbers exist in the compound, and two or more kinds of (XO) having different presence or absence of a side chain and a type of a side chain (for example, the number of side chains, the number of carbon atoms in side chains, and the like) exist even if the carbon numbers are the same.

For the disposition of two or more kinds of (XO), for example, a structure represented by {(CH₂O)ₘ₂₁(C₂H₄O)ₘ₂₂} represents that m21 pieces of (CH₂O) and m22 pieces of (C₂H₄O) are randomly disposed. In addition, the structure represented by (C₂H₄O—C₃H₆O)ₘ₂₅ represents that m25 pieces of (C₂H₄O) and m25 pieces of (C₃H₆O) are alternately disposed.

Among them, the (XO)ₘ is preferably [(CH₂O)ₘ₁₁(C₂H₄O)ₘ₁₂(OC₃H₆)ₘ₁₃(OC₄H₈)ₘ₁₄(C₅H₁₀O)ₘ₁₅(C₆H₁₂O)ₘ₁₆(cycloC₄H₆—O)ₘ₁₇(cycloC₅H₈—O)ₘ₁₈(cycloC₆H₁₀—O)_{m19].}

Each of m11, m12, m13, m14, m15, m16, m17, m18, and m19 independently is an integer of 0 or more, and preferably 100 or less.

m11+m12+m13+m14+m15+m16+m17+m18+m19 is an integer of 2 or more, and is more preferably an integer from 2 to 200, more preferably an integer from 5 to 150, still more preferably an integer from 5 to 100, particularly preferably an integer from 10 to 50.

Among them, m12 is preferably an integer of 2 or more, and particularly preferably an integer from 2 to 200.

In addition, C₃H₆, C₄H₈, C₅H₁₀, and C₆H₁₂ may be linear or branched, but are preferably linear from the viewpoint of improving the abrasion resistance of the surface treatment layer.

The above formula represents the type of unit and the number of units, and does not represent the sequence of units. That is, m11 to m19 represent the number of units, and for example, (CH₂O)ₘ₁₁ does not indicate a block in which m11 pieces of (CH₂O) units are continuous. Similarly, the description order of (CH₂O) to (cycloC₆H₁₀—O) does not indicate that they are disposed in the description order.

In the above formula, in a case in which two or more of m11 to m19 is not 0 (that is, in a case in which (XO)ₘ is made of two or more kinds of units), the sequence of different units may be any of a random sequence, an alternating sequence, a block sequence, and any combination of these sequences.

(XO)ₘ preferably has the following structure.
(C₂H₄O)ₘ₂₁,
(C₃H₆O)ₘ₂₂,
(C₂H₄O)ₘ₂₃(C₃H₆O)ₘ₂₄, and
(C₂H₄O—C₃H₆O)ₘ₂₅.

Herein, m21 is an integer of 2 or more, m22 is an integer of 2 or more, each of m23 and m24 independently is an integer of 1 or more, m25 is an integer of 1 or more.

The divalent organopolysiloxane residue is preferably represented by the following Formula B.

In Formula B, each R⁵ independently represents a hydrocarbon group, and k is an integer of 1 or more.

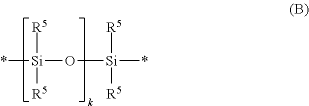

Examples of the hydrocarbon group represented by R⁵ include an aliphatic hydrocarbon group and an aromatic hydrocarbon group. Among them, the hydrocarbon group is preferably an aliphatic hydrocarbon group, and more preferably an alkyl group. The alkyl group may be any of a linear alkyl group, a branched alkyl group, and a cycloalkyl group, and is preferably a linear alkyl group, more preferably a methyl group, an ethyl group, a n-propyl group, or a n-butyl group, and still more preferably a methyl group.

k is an integer of 1 or more, preferably from 2 to 500, more preferably from 8 to 300, and still more preferably from 15 to 60. From the viewpoint of excellent abrasion resistance, from 9 to 50 is preferable, from 11 to 30 is more preferable, and from 11 to 25 is particularly preferable.

The combination of the alkylene chain and the divalent organopolysiloxane residue is preferably represented by the following Formula C1, C2, or C3.

In Formula C1, each of Ak¹ and Ak² independently means an alkylene chain. R⁵ represents the same as R⁵ in Formula B. k1 is an integer of 1 or more.

In Formula C2, Ak³ means an alkylene chain. R⁵ represents the same as R⁵ in Formula B. Each of k2 and k3 independently is an integer of 1 or more.

In Formula C3, Ak⁴ means an alkylene chain. R⁵ represents the same as R⁵ in Formula B. k4 is an integer of 1 or more.

In Formulas C1, C2, and C3, *1 is connected to the Group 1 side, and *2 is connected to the Group 2 side.

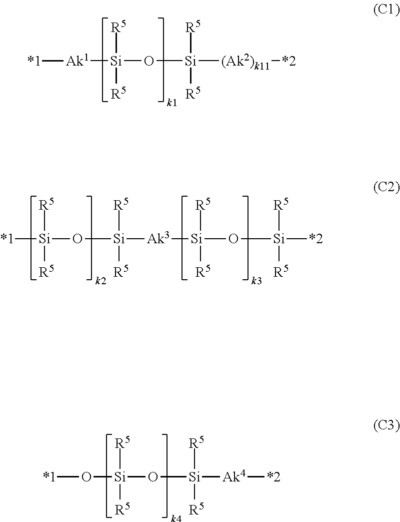

In Formula C1, the number of carbon atoms in the alkylene chain represented by Ak¹ is preferably 2 or more, more preferably 4 or more from the viewpoint of improving the water repellency and abrasion resistance of the surface treatment layer. The upper limit of the number of carbon atoms in the alkylene chain is not particularly limited, and is, for example, 30.

The number of carbon atoms in the alkylene chain represented by Ak² is preferably 2 or more, more preferably 4 or more from the viewpoint of improving the water repellency and abrasion resistance of the surface treatment layer. The upper limit of the number of carbon atoms in the alkylene chain is not particularly limited, and is, for example, 30. The number of carbon atoms in the alkylene chain represented by Ak² is preferably from 1 to 30, more preferably from 2 to 20, and still more preferably from 2 to 15.

The alkylene chain may be linear, branched, or cyclic.

Among them, the alkylene chain is preferably linear from the viewpoint of improving the water repellency and abrasion resistance of the surface treatment layer.

k1 is an integer of 1 or more, preferably from 2 to 500, more preferably from 8 to 300, and still more preferably from 15 to 60. From the viewpoint of excellent abrasion resistance, from 9 to 50 is preferable, from 11 to 30 is more preferable, and from 11 to 25 is particularly preferable.

k11 is 0 or 1.

In Formula C₂, the number of carbon atoms in the alkylene chain represented by Ak³ is preferably 2 or more, more preferably 4 or more from the viewpoint of improving the water repellency and abrasion resistance of the surface treatment layer. The upper limit of the number of carbon atoms in the alkylene chain is not particularly limited, and is, for example, 30.

The alkylene chain may be linear, branched, or cyclic.

Among them, the alkylene chain is preferably linear from the viewpoint of improving the water repellency and abrasion resistance of the surface treatment layer.

Each of k2 and k3 is independently an integer of 1 or more, preferably from 2 to 500, and more preferably from 8 to 300.

In Formula C3, the number of carbon atoms in the alkylene chain represented by Ak⁴ is preferably 2 or more, more preferably 4 or more from the viewpoint of improving the water repellency and abrasion resistance of the surface treatment layer. The upper limit of the number of carbon atoms in the alkylene chain is not particularly limited, and is, for example, 30. Specifically, the number of carbon atoms in the alkylene chain represented by Ak⁴ is preferably from 1 to 30, more preferably from 2 to 20, and still more preferably from 2 to 15.

The alkylene chain may be linear, branched, or cyclic.

Among them, the alkylene chain is preferably linear from the viewpoint of improving the water repellency and abrasion resistance of the surface treatment layer.

k4 is an integer of 1 or more, preferably from 2 to 500, more preferably from 8 to 300, and still more preferably from 15 to 60. From the viewpoint of excellent abrasion resistance, from 9 to 50 is preferable, from 11 to 30 is more preferable, and from 11 to 25 is particularly preferable.

The number average molecular weight (Mn) of the partial structure is preferably from 500 to 18,000, more preferably from 600 to 15,000, and particularly preferably from 700 to 10,000.

In a case in which Mn is 500 or more, the fluidity of the molecular chain of the compound is increased, and thus the abrasion resistance of the surface treatment layer is more excellent.

The compound of the disclosure is preferably represented by the following Formula 1 from the viewpoint of being more excellent in water repellency and abrasion resistance of the surface treatment layer.

[T-(O)ᵣ—Z]_{q}A(Si(R²)ₙL₃₋ₙ)ₚ (1)

In Formula 1, T represents a monovalent cyclic polysiloxane residue or a monovalent cage-like polysiloxane residue, r represents 0 or 1, Z represents an alkylene chain, a polyalkylene oxide chain, a divalent organopolysiloxane residue, or a combination thereof, A represents a single bond or a (p+q)-valent linking group, each R² independently represents a monovalent hydrocarbon group, each L independently represents a hydrolyzable group or a hydroxyl group, n represents an integer from 0 to 2, and each of p and q independently represents an integer of 1 or more.

T in Formula 1 is the same as that of the Group 1, and thus description thereof is omitted.

T is preferably represented by the above Formula T1. In Formula T1, each R³ is preferably independently an alkyl group having 1 to 4 carbon atoms.

R², L, and n in Formula 1 are the same as R², L, and n in the Group 2, and thus explanation thereof is omitted.

Z in Formula 1 is the same as the partial structure described above, and thus the description thereof is omitted.

Among them, Z is preferably an alkylene chain. The number of carbon atoms in the alkylene chain is preferably 6 or more, more preferably 10 or more, still more preferably 12 or more, particularly preferably 15 or more from the viewpoint of improving the water repellency and abrasion resistance of the surface treatment layer. The upper limit of the number of carbon atoms in the alkylene chain is not particularly limited, and is, for example, 30.

It is preferable that Z is represented by —Z¹—Z²—Z³—, each of Z¹ and Z³ is independently an alkylene chain, and Z² is a divalent organopolysiloxane residue.

The number of carbon atoms in the alkylene chain represented by Z¹ is preferably 6 or more, more preferably 10 or more from the viewpoint of improving the water repellency and abrasion resistance of the surface treatment layer. The upper limit of the number of carbon atoms in the alkylene chain is not particularly limited, and is, for example, 30.

The divalent organopolysiloxane residue represented by Z² is preferably represented by the above Formula B.

The number of carbon atoms in the alkylene chain represented by Z³ is preferably 6 or more, more preferably 10 or more from the viewpoint of improving the water repellency and abrasion resistance of the surface treatment layer. The upper limit of the number of carbon atoms in the alkylene chain is not particularly limited, and is, for example, 30.

That is, Z is preferably represented by the above Formula C1.

In Formula 1, A is a single bond or a (p+q)-valent linking group.

However, the terminal of A on the side bonded to Z is not any of an alkylene group, a polyalkylene oxide chain, and a divalent organopolysiloxane residue.

A only need to be any group that does not impair the effects of the present disclosure, and examples thereof include a carbon atom, a nitrogen atom, a silicon atom, and a group obtained by removing Si(R²)ₙL₃₋ₙ from the later-described Formulas (3-1A), (3-1B), and (3-1A-1) to (3-1A-7).

A may be a Group (g2-1) to a Group (g2-14) described later.

p is an integer from one or more. p is preferably from 1 to 15, more preferably from 1 to 6, still more preferably from 2 to 4, and particularly preferably 2 or 3 from the viewpoint of more excellent abrasion resistance of the surface treatment layer.

In a case in which p is 2 or more, a plurality of [Si(R²)ₙL₃₋ₙ] may be the same or different from each other.

q is an integer from one or more. q is preferably from 1 to 15, more preferably from 1 to 6, still more preferably from 1 to 4, and particularly preferably 1 or 2 from the viewpoint of more excellent abrasion resistance of the surface treatment layer.

In a case in which q is 2 or more, a plurality of [T-(O)ᵣ—Z] may be the same or different from each other.

The group represented by A(Si(R²)ₙL₃₋ₙ)_{q} in Formula 1 is preferably a Group (3-1A) or a Group (3-1B), and more preferably a Group (3-1 A).

-Q^{a}-X³¹(-Q^{b}-Si(R²)ₙL₃₋ₙ)ₕ(—R³¹)ᵢ (3-1A)

-Q^{c}-[CH₂C(R³²)(-Q^{d}-Si(R²)ₙL₃₋ₙ)]_{y}-R³³ (3-1B)

In Formulas (3-1A) and (3-1B), the definitions of R², L, and n are as described above.

In Formula (3-1A), Q^{a} represents a single bond or a divalent linking group.

However, the terminal of Q^{a} on the side bonded to Z is not any of an alkylene group, a polyalkylene oxide chain, and a divalent organopolysiloxane residue.

Examples of the divalent linking group include a divalent hydrocarbon group, a divalent heterocyclic group, —O—, —S—, —SO₂—, —N(R^{d})—, —C(O)—, —Si(R^{a})₂—, and a group obtained by combining the two or more kinds of groups of them.

The divalent hydrocarbon group may be a divalent saturated hydrocarbon group, a divalent aromatic hydrocarbon group, an alkenylene group, or an alkynylene group. The divalent saturated hydrocarbon group may be linear, branched, or cyclic, and examples thereof include an alkylene group. The number of carbon atoms is preferably from 1 to 20. The divalent aromatic hydrocarbon group is preferably one having 5 to 20 carbon atoms, and examples thereof include a phenylene group. An alkenylene group having 2 to 20 carbon atoms and an alkynylene group having 2 to 20 carbon atoms may be used.

The R^{a} is an alkyl group (preferably having 1 to 10 carbon atoms) or a phenyl group. The R^{d} is a hydrogen atom or an alkyl group (preferably having 1 to 10 carbon atoms).

Examples of the group in combination of the two or more kinds of groups of them include:

—OC(O)—, —C(O)O—, —C(O)S—, —C(O)N(R^{d})—, —N(R^{d})C(O)—, —N(R^{d})C(O)N(R^{d})—, —N(R^{d})C(O)O—, —OC(O)N(R^{d})—, —SO₂N(R^{d})—, —N(R^{d})SO₂—, an alkylene group having —C(O)N(R^{d})—; an alkylene group having —N(R^{d})C(O)—, an alkylene group having —OC(O)N(R^{d})—, and an alkylene group having an etheric oxygen atom, an alkylene group having —S—, an alkylene group having —OC(O)—, an alkylene group having —C(O)O—, an alkylene group having —C(O)S—, an alkylene group having —N(R^{d})—, an alkylene group having —N(R^{d})C(O)N(R^{d})—, and an alkylene group having —SO₂N(R^{d})—.

Among them, in a case in which an A side terminal of Z is an alkylene chain, Q^{a} is preferably a divalent hydrocarbon group other than an alkylene group, a divalent heterocyclic group, —O—, —S—, —SO₂—, —N(R^{d})—, —C(O)—, —Si(R^{a})₂—, —OC(O)—, —C(O)O—, —C(O)S—, —C(O)N(R^{d})—, —N(R^{d})C(O)—, —N(R^{d})C(O)N(R^{d})—, —N(R^{d})C(O)O—, —OC(O)N(R^{d})—, —SO₂N(R^{d})—, —N(R^{d})SO₂—, an alkylene group having —C(O)N(R^{d})—, an alkylene group having —N(R^{d})C(O)—, an alkylene group having —OC(O)N(R^{d})—, an alkylene group having an etheric oxygen atom, an alkylene group having —S—, an alkylene group having —OC(O)—, an alkylene group having —C(O)O—, an alkylene group having —C(O)S—, an alkylene group having —N(R^{d})—, an alkylene group having —N(R^{d})C(O)N(R^{d})—, or an alkylene group having —SO₂N(R^{d})—, more preferably an alkylene group having —OC(O)—, —C(O)N(R^{d})—, an alkylene group having —OC(O)N(R^{d})—, an alkylene group having an etheric oxygen atom, an alkylene group having —S—, an alkylene group having —C(O)O—, an alkylene group having —C(O)S—, an alkylene group having —N(R^{d})—, or an alkylene group having —N(R^{d})C(O)N(R^{d})—, and still more preferably an alkylene group having —C(O)O— or an alkylene group having —C(O)N(R^{d})—.

In a case in which an A side terminal of Z is a polyalkylene oxide chain, Q^{a} is preferably a divalent hydrocarbon group other than an alkylene group, a divalent heterocyclic group, —SO₂—, —C(O)—, —Si(R^{a})₂—, —C(O)O—, —C(O)S—, —C(O)N(R^{d})—, —SO₂N(R^{d})—, an alkylene group having —C(O)N(R^{d})—, an alkylene group having —C(O)O—, or an alkylene group having —SO₂N(R^{d})—, and more preferably —C(O)—.

In a case in which the A side terminal of Z is a divalent organopolysiloxane residue, Q^{a} is preferably a divalent hydrocarbon group other than an alkylene group, a divalent heterocyclic group, an alkylene group having —O—, —S—, —SO₂—, —N(R^{d})—, —C(O)—, —Si(R^{a})₂—, —OC(O)—, —C(O)O—, —C(O)S—, —C(O)N(R^{d})—, —N(R^{d})C(O)—, —N(R^{d})C(O)N(R^{d})—, —N(R^{d})C(O)O—, —OC(O)N(R^{d})—, —SO₂N(R^{d})—, —N(R^{d})SO₂—, —C(O)N(R^{d})—, an alkylene group having —N(R^{d})C(O)—, an alkylene group having —OC(O)N(R^{d})—, an alkylene group having an etheric oxygen atom, an alkylene group having —S—, an alkylene group having —OC(O)—, an alkylene group having —C(O)O—, an alkylene group having —C(O)S—, an alkylene group having —N(R^{d})—, an alkylene group having —N(R^{d})C(O)N(R^{d})—, or an alkylene group having —SO₂N(R^{d})—.

In Formula (3-1A), X³¹ is a single bond, an alkylene group, a carbon atom, a nitrogen atom, a silicon atom, a divalent to octavalent organopolysiloxane residue, or a group having a (h+i+1)-valent ring.

In a case in which Q^{a} is a single bond, the terminal of X³¹ on the side bonded to Z is not any of an alkylene group, a polyalkylene oxide chain, and a divalent organopolysiloxane residue. In cases other than the above, the terminal of X³¹ may be any of an alkylene group, a polyalkylene oxide chain, and a divalent organopolysiloxane residue.

The alkylene group represented by X³¹ may have —O—, a silphenylene skeleton group, a divalent organopolysiloxane residue, or a dialkylsilylene group. The alkylene group may have a plurality of groups selected from the group consisting of a —O—, silphenylene skeleton group, a divalent organopolysiloxane residue, and a dialkylsilylene group.

The number of carbon atoms of the alkylene group represented by X³¹ is preferably from 1 to 20, and more preferably from 1 to 10.

Examples of the divalent to octavalent organopolysiloxane residue include a divalent organopolysiloxane residue and a (w+1)-valent organopolysiloxane residue described later.

In Formula (3-1A), in a case in which X³¹ is a group having a (h+i+1)-valent ring, Q^{a}, (-Q^{b}-Si(R²)ₙL₃₋ₙ), and R³¹ are directly bonded to atoms constituting the ring. However, the ring is a ring other than the organopolysiloxane ring.

The ring in X³¹ may be any of a monocyclic ring, a fused polycyclic ring, a bridged ring, a spiro ring, and an assembled polycyclic ring, and the atom constituting the ring may be a carbocyclic ring composed of only carbon atoms, or may be a heterocyclic ring composed of a hetero atom having a divalent or above and a carbon atom. The bond between atoms constituting the ring may be a single bond or a multiple bond. The ring may be an aromatic ring or a non-aromatic ring.

The monocyclic ring is preferably a 4-membered ring to an 8-membered ring, and more preferably a 5-membered ring or a 6-membered ring. The fused polycyclic ring is preferably a fused polycyclic ring in which two or more rings of 4-membered to 8-membered rings are fused, and more preferably a fused polycyclic ring in which 2 or 3 rings selected from a 5-membered ring and a 6-membered ring are bonded, and a fused polycyclic ring in which one or two rings selected from a 5-membered ring and a 6-membered ring and one 4-membered ring are bonded. The bridged ring is preferably a bridged ring having a 5-membered ring or a 6-membered ring as the largest ring, and the spiro ring is preferably a spiro ring as a component of two of 4-membered to 6-membered rings. The assembled polycyclic ring is preferably an assembled polycyclic ring in which 2 or 3 rings selected from a 5-membered ring and a 6-membered ring are bonded via a single bond, 1 to 3 carbon atoms, or one heteroatom having a valence of 2 or 3. In the assembled polycyclic ring, any one of Q^{a}, (-Q^{b}-Si(R²)ₙL₃₋ₙ) and R³¹ (in a case in which i=1 or more) is preferably bonded to each ring.

As the hetero atom constituting the ring, a nitrogen atom, an oxygen atom, and a sulfur atom are preferable, and a nitrogen atom and an oxygen atom are more preferable. The number of the heteroatoms constituting the ring is preferably 3 or less. When the number of the heteroatoms constituting the ring is two or more, those heteroatoms may be different.

The ring for X³¹ is preferably one kind selected from the group consisting of a 3-membered to 8-membered aliphatic rings, a benzene ring, 3-membered to 8-membered heterocyclic rings, a fused ring in which 2 or 3 rings of these rings are fused, a bridged ring having a 5-membered ring or a 6-membered ring as the largest ring, and an assembled polycyclic ring which has the two or more rings of these rings and in which the linking group is a single bond, an alkylene group having 3 or less carbon atoms, an oxygen atom or a sulfur atom, from the viewpoint of easily producing a compound and being further excellent in the abrasion resistance of the surface treatment layer.

Preferred rings are benzene rings, 5 or 6 membered aliphatic rings, 5 or 6 membered heterocycles having a nitrogen atom or an oxygen atom, and fused rings of 5 or 6 membered carbocycles and from 4 to 6 membered heterocycles.

Specific examples of the ring include the following rings, 1,3-cyclohexadiene ring, 1,4-cyclohexadiene ring, anthracene ring, cyclopropane ring, decahydronaphthalene ring, norbornene ring, norbornadiene ring, furan ring,
pyrrole ring, thiophene ring, pyrazine ring, morpholine ring, aziridine ring, isoquinoline ring, oxazole ring, isoxazole ring, thiazole ring, imidazole ring, pyrazole ring, pyran ring, pyridazine ring, pyrimidine ring, and indene ring. A ring having an oxo group (═O) is also described below.

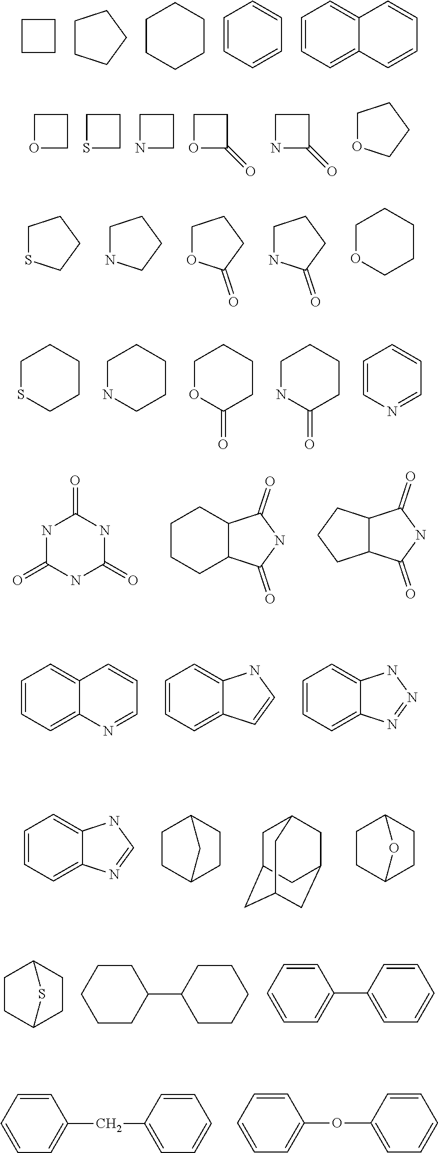

A bond that does not constitute a ring of atoms constituting the ring in X³¹ is a bond bonded to Q^{a}, (Q^{b}-Si(R²)ₙL₃₋ₙ), or R³¹. When there are remaining bonds, the remaining bonds are bonded to a hydrogen atom or a substituent. Examples of the substituent include a halogen atom, an alkyl group (an etheric oxygen atom may be contained between the carbon-carbon atoms), a cycloalkyl group, an alkenyl group, an allyl group, an alkoxy group, and an oxo group (═O).

In a case in which one of the carbon atoms constituting the ring has two bonds bonded to Q^{a}, (-Q^{b}-Si(R²)ₙL₃₋ₙ) or R³¹, Q^{a} and (-Q^{b}-Si(R²)ₙL₃₋ₙ) may be bonded to one of the carbon atoms, or two (-Q^{b}-Si(R²)ₙL₃₋ₙ) may be bonded to one of the carbon atoms. Q^{a}, and (-Q^{b}-Si(R²)ₙL₃₋ₙ) or R³¹ are preferably bonded to another ring-constituting atom. Each of h pieces of (-Q^{b}-Si(R²)ₙL₃₋ₙ) may be bonded to a separate ring-constituting atom, and two of h pieces of (-Q^{b}-Si(R²)ₙL₃₋ₙ) may be bonded to one ring-constituting carbon atom, and there may be two or more ring-constituting carbon atoms to which two pieces of (-Q^{b}-Si(R²)ₙL₃₋ₙ) are bonded. Each of i pieces of R³¹ may be bonded to a separate ring-constituting atom, two pieces of R³¹ may be bonded to one ring-constituting carbon atom, and further, there may be two or more ring-constituting carbon atoms to which two pieces of R³¹ are bonded.

Among them, from the viewpoint of improving the abrasion resistance of the surface treatment layer, X³¹ is preferably a carbon atom, a nitrogen atom, a silicon atom, quadrivalent to octavalent organopolysiloxane residue, or a group having a (h+i+1) valent ring, and more preferably a carbon atom.

In Formula (3-1A), Q^{b} represents a single bond or a divalent linking group.

The definition of the divalent linking group is the same as the definition described in Q^{a} described above.

In a case in which Q^{a} and X³¹ are a single bond, the terminal of Q^{b} on the side bonded to Z is not any of an alkylene group, a polyalkylene oxide chain, and a divalent organopolysiloxane residue. In cases other than the above, the terminal of Q^{b} may be any of an alkylene group, a polyalkylene oxide chain, and a divalent organopolysiloxane residue.

Among them, Q^{b} is preferably an alkylene group which may have an etheric oxygen atom. The number of carbon atoms in the alkylene group is preferably from 1 to 30, more preferably from 1 to 20, still more preferably from 2 to 20, and may be from 2 to 10, from 2 to 6, or from 2 to 5. Examples thereof include 2, 3, 8, 9, and 11. The number of carbon atoms may be from 1 to 10.

In Formula (3-1A), R³¹ is a hydrogen atom, a hydroxyl group, or an alkyl group.

The number of carbon atoms in the alkyl group is preferably from 1 to 5, more preferably from 1 to 3, and still more preferably 1.

When X³¹ is a single bond or an alkylene group, h is 1, and i is 0;
when X³¹ is a nitrogen atom, h is an integer from 1 to 2, i is an integer from 0 to 1, and h+i=2 is satisfied;
when X³¹ is a carbon atom or a silicon atom, h is an integer from 1 to 3, i is an integer from 0 to 2, and h+i=3 is satisfied; and
when X³¹ is a divalent to octavalent organopolysiloxane residue, h is an integer from 1 to 7, i is an integer from 0 to 6, and h+i=1 to 7 is satisfied.

When X³¹ is a group having a (h+i+1)-valent ring, h is an integer from 1 to 7, i is an integer from 0 to 6, and h+i=1 to 7 is satisfied.

In a case in which there are two or more pieces of (-Q^{b}-Si(R)ₙL₃₋ₙ), two or more pieces of (-Q^{b}-Si(R)ₙL₃₋ₙ) may be the same or different from each other. When there are two or more pieces of R³¹, two or more pieces of (—R³¹) may be the same or different from each other.

Among them, i is preferably 0 from the viewpoint of improving the abrasion resistance of the surface treatment layer.

In Formula (3-1A), in a case in which Q^{a}, X³¹, and Q^{b} have a single bond, [Si(R²)ₙL₃₋ₙ] is directly bonded to Z, and Z is an alkylene chain.

In Formula (3-1B), Q^{c} represents a single bond or a divalent linking group.

The terminal of Q^{c} on the side bonded to Z is not any of an alkylene group, a polyalkylene oxide chain, and a divalent organopolysiloxane residue.

The definition of the divalent linking group is the same as the definition described in Q^{a} described above.

In Formula (3-1B), R³² is a hydrogen atom or an alkyl group having 1 to 10 carbon atoms, and is preferably a hydrogen atom from the viewpoint of easily producing a compound.

The alkyl group is preferably a methyl group.

In Formula (3-1B), Q^{d} is a single bond or an alkylene group. The number of carbon atoms in the alkylene group is preferably from 1 to 10, and more preferably from 1 to 6. Q^{d} is preferably a single bond or —CH₂— from the viewpoint of easily producing a compound.

In Formula (3-1B), R³³ is a hydrogen atom or a halogen atom, and is preferably a hydrogen atom from the viewpoint of easily producing a compound.

y is an integer from 1 to 10 and preferably an integer from 1 to 6.

Two or more pieces of [CH₂C(R³²)(-Q^{d}-Si(R²)ₙL₃₋ₙ)] may be the same or different from each other.

As the Group (3-1A), Groups (3-1A-1) to (3-1A-7) are preferable.

—(X³²)ₛ₁-Q^{b1}-Si(R²)ₙL₃₋ₙ (3-1A-1)

—(X³³)ₛ₂-Q^{a2}-N[-Q^{b2}-Si(R²)ₙL₃₋ₙ]₂ (3-1A-2)

-Q^{a3}-Si(R^{g})[-Q^{b3}-Si(R²)ₙL₃₋ₙ]₂ (3-1A-3)

-[Q^{e}]ₛ₄-Q^{a4}-(O)ₜ₄—C[—(O)ᵤ₄-Q^{b4}-Si(R²)ₙL₃₋ₙ]_{3-w1}(—R³¹)w1 (3-1A-4)

-Q^{a5}-Si[-Q^{b5}-Si(R²)ₙL₃₋ₙ]₃ (3-1A-5)

-[Q^{e}]ᵥ-Q^{a6}-Z^{a}[-Q^{b6}-Si(R²)ₙL₃₋ₙ]_{w2} (3-1A-6)

-[Q^{e}]ₛ₄-Q^{a4}-(O)ₜ₄—Z^{c}[—(O-Q^{b4})ᵤ₄-Si(R²)ₙL₃₋ₙ]_{w3}(—OH)_{w4} (3-1A-7)

In Formulas (3-1A-1) to (3-1A-7), the definitions of R², L, and n are as described above.

The terminal of the Groups (3-1A-1) to (3-1A-7) on the side bonded to Z is not any of an alkylene group, a polyalkylene oxide chain, or a divalent organopolysiloxane residue.

In the Group (3-1A-1), X³² is —O—, —S—, —N(R^{d})—, —C(O)—, —C(O)O—, —C(O)S—, —SO₂N(R^{d})—, —N(R^{d})SO₂—, —N(R^{d})C(O)—, —N(R^{d})C(O)N(R^{d})—, —OC(O)N(R^{d})—, or —C(O)N(R^{d})— (however, N in the formulas binds to Q^{b1})

The definition of R^{d} is as described above.
s1 is 0 or 1.

Among them, in a case in which the A side terminal of Z is an alkylene chain, X³² is preferably —O—, —S—, —N(R^{d})—, —C(O)—, —C(O)O—, —C(O)S—, —SO₂N(R^{d})—, —N(R^{d})SO₂—, —N(R^{d})C(O)—, —N(R^{d})C(O)N(R^{d})—, —OC(O)N(R^{d})—, or —C(O)N(R^{d})—, more preferably —O—, —S—, —N(R^{d})—, —C(O)—, —C(O)S—, —N(R^{d})C(O)—, —N(R^{d})C(O)N(R^{d})—, —OC(O)N(R^{d})— or —C(O)N(R^{d})—, and still more preferably —C(O)O— or —N(R^{d})C(O)—.

In a case in which the A side terminal of Z is a polyalkylene oxide chain, X³² is preferably —C(O)—, —C(O)O—, —C(O)S—, —SO₂N(R^{d})—, or —C(O)N(R^{d})—, more preferably —C(O)—.

In a case in which the A side terminal of Z is a divalent organopolysiloxane residue, X³² is preferably —O—, —S—, —N(R^{d})—, —C(O)—, —C(O)O—, —C(O)S—, —SO₂N(R^{d})—, —N(R^{d})SO₂—, —N(R^{d})C(O)—, —N(R^{d})C(O)N(R^{d})—, —OC(O)N(R^{d})—, or —C(O)N(R^{d})—, more preferably —O—.

Q^{b1} is a single bond or an alkylene group. The alkylene group may have a —O—, silphenylene skeleton group, or a dialkylsilylene group.

In a case in which s1 is 0, the A side terminal of Q^{b1} is not an alkylene group.

The alkylene group may have a plurality of groups selected from the group consisting of a —O—, silphenylene skeleton group, a divalent organopolysiloxane residue, and a dialkylsilylene group.

When the alkylene group has a —O—, silphenylene skeleton group, a divalent organopolysiloxane residue, or a dialkylsilylene group, it is preferable to have these groups between carbon-carbon atoms.

The number of carbon atoms of the alkylene group represented by Q^{b1} is preferably from 1 to 30, more preferably from 1 to 20, still more preferably from 2 to 20, and particularly preferably from 2 to 6. The number of carbon atoms may be from 1 to 10.

Among them, in a case in which the A side terminal of Z is an alkylene chain, it is preferable that s1 is 0 and Q^{b1} is a single bond, or s1 is 1 and Q^{b1} is an alkylene group having from 2 to 6 carbon atoms.

In a case in which the A side terminal of Z is a polyalkylene oxide chain, s1 is preferably 1, and Q^{b1} is preferably an alkylene group having from 2 to 6 carbon atoms.

In a case in which the A side terminal of Z is a divalent organopolysiloxane residue, s1 is preferably 1, and Q^{b1} is preferably a single bond.

In a case in which the A side terminal of Z is an alkylene chain, specific examples of the Group (3-1A-1) include the following group. In the following formula, * represents a bonding position with Z.

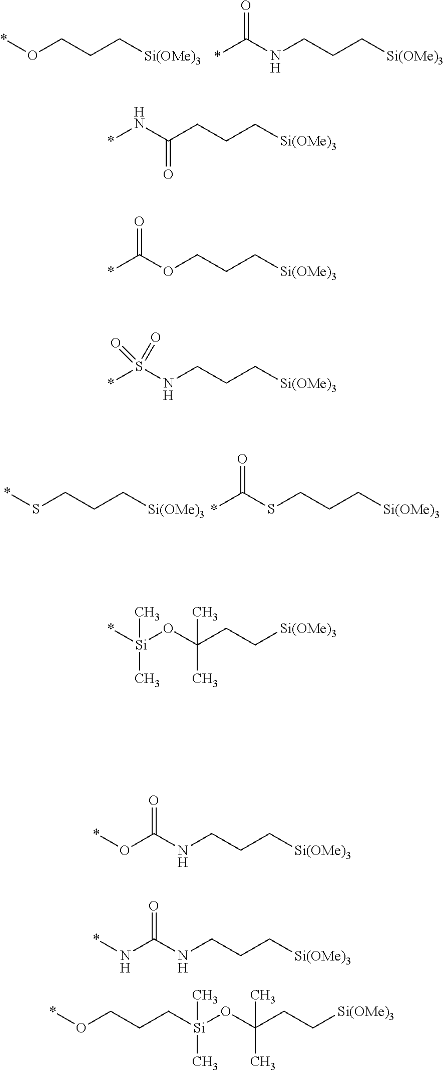

In a case in which the A side terminal of Z is a polyalkylene oxide chain, specific examples of the Group (3-1A-1) include the following group. In the following formula, * represents a bonding position with Z.

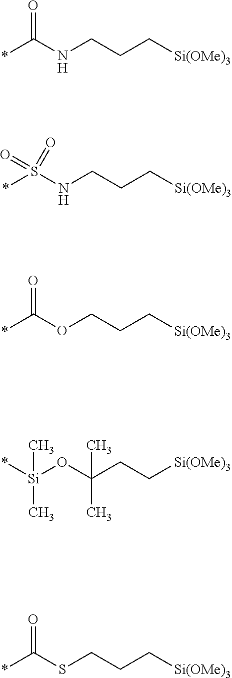

In a case in which the A side terminal of Z is a divalent organopolysiloxane residue, specific examples of the Group (3-1A-1) include the following group. In the following formula, * represents a bonding position with Z.

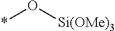

In the Group (3-1A-2), X³³ is —O—, —S—, —N(R^{d})—, —C(O)—, —C(O)O—, —C(O)S—, —SO₂N(R^{d})—, —N(R^{d})SO₂—, —N(R^{d})C(O)—, —N(R^{d})C(O)N(R^{d})—, —OC(O)N(R^{d})—, or —C(O)N(R^{d})—.

The definition of R^{d} is as described above.
s2 is 0 or 1. s2 is preferably 0 from the viewpoint of easily producing a compound.

Among them, when the A side terminal of Z is an alkylene chain or a divalent organopolysiloxane residue, X³³ is preferably —O—, —S—, —N(R^{d})—, —C(O)—, —C(O)O—, —C(O)S—, —SO₂N(R^{d})—, —N(R^{d})SO₂—, —N(R^{d})C(O)—, —N(R^{d})C(O)N(R^{d})—, —OC(O)N(R^{d})—, or —C(O)N(R^{d})—.

In a case in which the A side terminal of Z is a polyalkylene oxide chain, X³³ is preferably —C(O)O—, —C(O)S—, —SO₂N(R^{d})—, or —C(O)N(R^{d})—.

Q^{a2} is a group having a single bond, an alkylene group, —C(O)—, or a group having an etheric oxygen atom, —C(O)—, —C(O)O—, —OC(O)—, —C(O)N(R^{d})—, —N(R^{d})C(O)—, —N(R^{d})C(O)N(R^{d})—, —N(R^{d})C(O)O—, —OC(O)N(R^{d})—, —SO₂N(R^{d})—, —N(R^{d})SO₂—, —C(O)N(R^{d})—, or —NH— between carbon-carbon atoms of an alkylene group having two or more carbon atoms.

In a case in which s2 is 0, the A side terminal Q^{a2} is not an alkylene group.

The number of carbon atoms of the alkylene group represented by Q^{a2} is preferably from 1 to 20, more preferably from 1 to 10, still more preferably from 1 to 6, and particularly preferably from 1 to 3.

The number of carbon atoms of a group having an etheric oxygen atom, —C(O)—, —C(O)O—, —OC(O)—, —C(O)N(R^{d})—, —N(R^{d})C(O)—, —N(R^{d})C(O)N(R^{d})—, —N(R^{d})C(O)O—, —OC(O)N(R^{d})—, —SO₂N(R^{d})—, —N(R^{d})SO₂—, —C(O)N(R^{d})—, or —NH— between carbon-carbon atoms of the alkylene group having two or more carbon atoms represented by Q^{a2} is preferably from 2 to 10, more preferably from 2 to 6.

Q^{a2} is preferably a single bond from the viewpoint of easily producing a compound.

Q^{b2} is an alkylene group or a group having a divalent organopolysiloxane residue, an etheric oxygen atom, or —NH— between carbon-carbon atoms of an alkylene group having two or more carbon atoms.

The number of carbon atoms in the alkylene group represented by Q^{b2} is preferably from 1 to 30, more preferably from 1 to 20, still more preferably from 2 to 20, and may be from 2 to 10, from 2 to 6. Examples thereof include 2, 3, 8, 9, and 11. The number of carbon atoms may be from 1 to 10.

The number of carbon atoms of a divalent organopolysiloxane residue, an etheric oxygen atom, or a group having —NH— between carbon-carbon atoms of the alkylene group having two or more carbon atoms represented by Q^{b2} is preferably from 2 to 10, and more preferably from 2 to 6.

Q^{b2} is preferably —CH₂CH₂CH₂— or —CH₂CH₂O CH₂CH₂CH₂— from the viewpoint of easily producing a compound (however, the right side is bonded to Si).

Two pieces of [-Q^{b2}-Si(R²)ₙL₃₋ₙ] may be the same or different from each other.

In a case in which the A side terminal of Z is an alkylene chain or a divalent organopolysiloxane residue, specific examples of the Group (3-1A-2) include the following group. In the following formula, * represents a bonding position with Z. In the formula, a in (CH₂)_{α} bonded to the reactive silyl group is an integer representing the number of methylene groups, and is preferably from 1 to 30, more preferably from 1 to 20, still more preferably from 2 to 20, may be from 2 to 10, or may be from 2 to 6. Examples thereof include 2, 3, 8, 9, and 11. The number of carbon atoms may be from 1 to 10. A plurality of α contained in the same compound may be the same or different from each other, but is preferably the same. For example, the plurality of a contained in the same compound is all 2, 3, 8, 9, and 11. The same applies hereinafter.

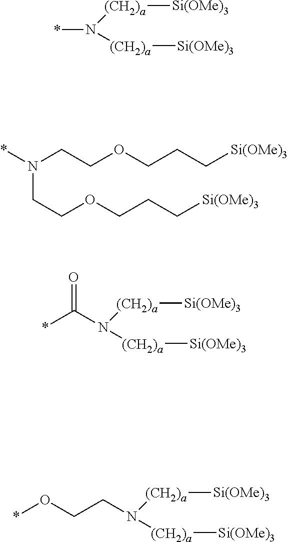

When the A side terminal of Z is a polyalkylene oxide chain, specific examples of the Group (3-1A-2) include the following groups. In the following formula, * represents a bonding position with Z.

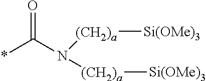

In the Group (3-1A-3), Q^{a3} is a single bond or an alkylene group optionally having an etheric oxygen atom. Q^{a3} is preferably a single bond from the viewpoint of easily producing a compound.

The number of carbon atoms of the alkylene group optionally having an etheric oxygen atom is preferably from 1 to 10, and particularly preferably from 2 to 6.

R^{g} is a hydrogen atom, a hydroxyl group, or an alkyl group.

R^{g} is preferably a hydrogen atom or an alkyl group from the viewpoint of easily producing a compound. The number of carbon atoms in the alkyl group is preferably from 1 to 10, more preferably from 1 to 4, and still more preferably a methyl group.

Q^{b3} is an alkylene group or a group having an etheric oxygen atom or a divalent organopolysiloxane residue between carbon-carbon atoms of the alkylene group having two or more carbon atoms.

The number of carbon atoms in the alkylene group represented by Q^{b3} is preferably from 1 to 30, more preferably from 1 to 20, still more preferably from 2 to 20, and may be from 2 to 10, from 2 to 6. Examples thereof include 2, 3, 8, 9, and 11. The number of carbon atoms may be from 1 to 10.

The number of carbon atoms of the group having an etheric oxygen atom or a divalent organopolysiloxane residue between carbon-carbon atoms of the alkylene group having two or more carbon atoms represented by Q^{b3} is preferably from 2 to 20, more preferably from 2 to 10, and still more preferably from 2 to 6.

Q^{b3} is preferably —CH₂CH₂—, —CH₂CH₂CH₂—, or —CH₂CH₂CH₂CH₂CH₂CH₂CH₂CH₂— from the viewpoint of easily producing a compound.

Two pieces of [-Q^{b3}-Si(R²)ₙL₃₋ₙ] may be the same or different from each other.

In a case in which the A side terminal of Z is an alkylene chain or a divalent organopolysiloxane residue, specific examples of the Group (3-1A-3) include the following group. In the following formula, * represents a bonding position with Z.

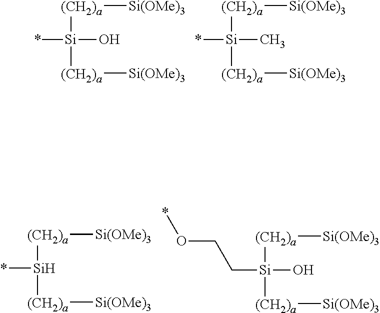

In a case in which the A side terminal of Z is a polyalkylene oxide chain, specific examples of the Group (3-1A-3) include the following groups. In the following formula, * represents a bonding position with Z.

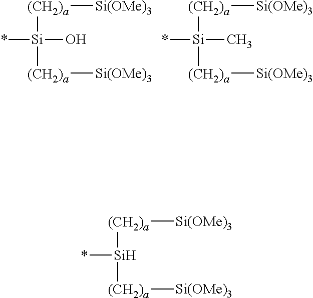

In the Group (3-1A-4), Q^{e} represents —C(O)O—, —SO₂N(R^{d})—, —N(R^{d})SO₂—, —N(R^{d})C(O)—, or —C(O)N(R^{d})—.

The definition of R³¹ is as described above.

s4 is 0 or 1.

Q^{a4} is a single bond or an alkylene group optionally having an etheric oxygen atom.

In a case in which s4 is 0, the A side terminal of Q^{a4} is not an alkylene group.

The number of carbon atoms of the alkylene group optionally having an etheric oxygen atom is preferably from 1 to 10, and particularly preferably from 2 to 6.

t4 is 0 or 1(however, when Q^{a4} is a single bond, Q^{a4} is 0).

As -Q^{a4}-(O)ₜ₄—, a single bond is preferable in a case in which s4 is 0, a single bond, —CH₂—, and —CH₂CH₂— are preferable in a case in which s4 is 1, from the viewpoint of easily producing a compound.

Q^{b4} is an alkylene group, and the alkylene group may have —O—, —C(O)N(R^{d})— (the definition of R^{d} is as described above), a silphenylene skeleton group, a divalent organopolysiloxane residue, or a dialkylsilylene group.

When the alkylene group has a —O— or silphenylene skeleton group, the alkylene group preferably has a —O— or silphenylene skeleton group between carbon-carbon atoms. When the alkylene group has —C(O)N(R^{d})—, a dialkylsilylene group, or a divalent organopolysiloxane residue, it is preferable to have these groups between carbon-carbon atoms or at the terminal on the side which is bonded to (O)ᵤ₄.

The number of carbon atoms in the alkylene group represented by Q^{b4} is preferably from 1 to 30, more preferably from 1 to 20, still more preferably from 2 to 20, and may be from 2 to 10, from 2 to 6. Examples thereof include 2, 3, 8, 9, and 11. The number of carbon atoms may be from 1 to 10.

u4 is 0 or 1.

As —(O)ᵤ₄-Q^{b4}-, —CH₂CH₂—, —CH₂CH₂CH₂—, —CH₂O CH₂CH₂CH₂—, —CH₂O CH₂CH₂CH₂CH₂CH₂—, —OCH₂CH₂CH₂—, —OSi(CH₃)₂CH₂CH₂CH₂—, —OSi(CH₃)₂OSi(CH₃)₂CH₂CH₂CH₂—, —CH₂CH₂CH₂Si(CH₃)₂PhSi(CH₃)₂CH₂CH₂— are preferable from the viewpoint of easily producing a compound (however, the right side is bonded to Si).

w1 is an integer from 0 to 2, preferably 0 or 1, and particularly preferably 0.

In a case in which there are two or more pieces of [—(O)ᵤ₄-Q^{b4}-Si(R²)ₙL₃₋ₙ], two or more pieces of [—(O)ᵤ₄-Q^{b4}-Si(R²)ₙL₃₋ₙ] may be the same or different from each other.

When there are two or more pieces of R³¹, two or more pieces of (—R³¹) may be the same or different from each other.

When the A side terminal of Z is an alkylene chain or a divalent organopolysiloxane residue, specific examples of the Group (3-1A-4) include the following group. In the following formula, * represents a bonding position with Z.

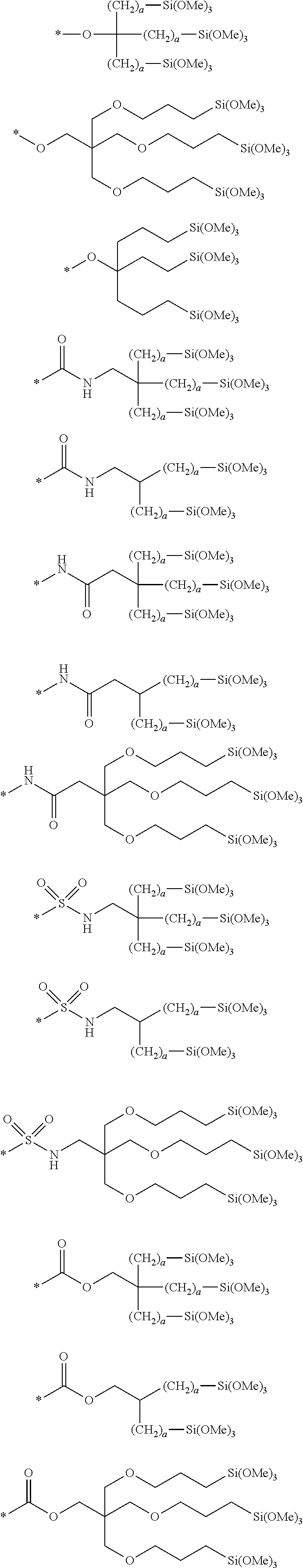

In a case in which the A side terminal of Z is a polyalkylene oxide chain, specific examples of the Group (3-1A-4) include the following groups. In the following formula, * represents a bonding position with Z.

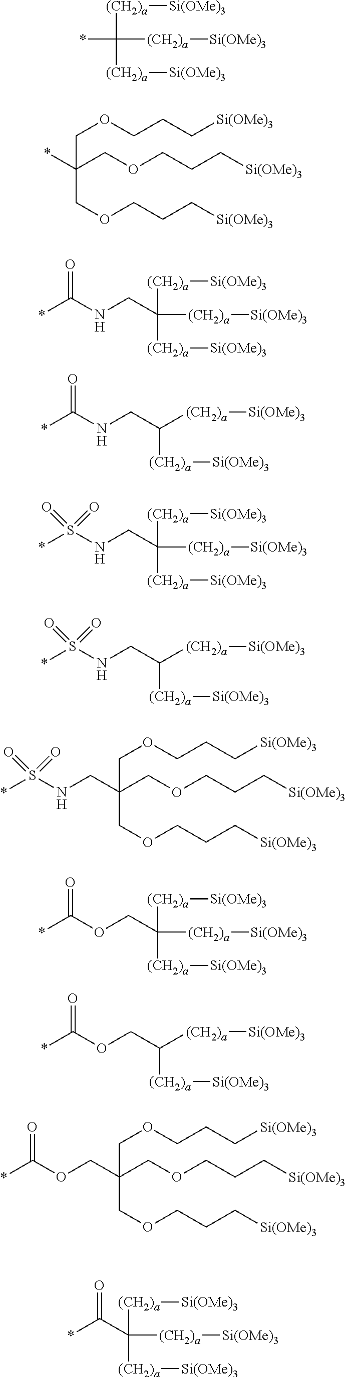

In the Group (3-1A-5), Q^{a5} is an alkylene group optionally having an etheric oxygen atom.

The A side terminal of Q^{a5} is not an alkylene group.

The number of carbon atoms of the alkylene group optionally having an etheric oxygen atom is preferably from 1 to 10, and particularly preferably from 2 to 6.

Q^{a5} is preferably —OCH₂CH₂CH₂— or —OCH₂CH₂OCH₂CH₂CH₂— from the viewpoint of easily producing a compound (the right side is bonded to Si).

Q^{b5} is an alkylene group or a group having an etheric oxygen atom or a divalent organopolysiloxane residue between carbon-carbon atoms of the alkylene group having two or more carbon atoms.

The number of carbon atoms in the alkylene group represented by Q^{b5} is preferably from 1 to 30, more preferably from 1 to 20, still more preferably from 2 to 20, and may be from 2 to 10, from 2 to 6. Examples thereof include 2, 3, 8, 9, and 11. The number of carbon atoms may be from 1 to 10.

The number of carbon atoms of the group having an etheric oxygen atom or a divalent organopolysiloxane residue between carbon-carbon atoms of the alkylene group having two or more carbon atoms represented by Q^{b5} is preferably from 2 to 20, more preferably from 2 to 10, and still more preferably from 2 to 6.

Q^{b5} is preferably —CH₂CH₂CH₂— or —CH₂CH₂OCH₂CH₂CH₂— from the viewpoint of easily producing a compound (however, the right side is bonded to Si(R²)ₙL₃₋ₙ).

Three pieces of [-Q^{b5}-Si(R²)ₙL₃₋ₙ] may be the same or different from each other.

When the A side terminal of Z is an alkylene chain or a divalent organopolysiloxane residue, specific examples of the Group (3-1A-5) include the following group. In the following formula, * represents a bonding position with Z.

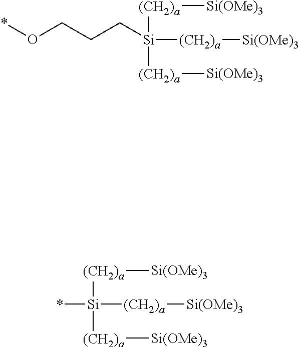

In a case in which the A side terminal of Z is a polyalkylene oxide chain, specific examples of the Group (3-1A-5) include the following groups. In the following formula, * represents a bonding position with Z.

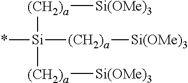

The definition of Q^{e} in Group (3-1A-6) is as defined in the Group (3-1A-4).

v is 0 or 1.

Q^{a6} is an alkylene group optionally having an etheric oxygen atom.

In a case in which v is 0, the A side terminal of Q^{a6} is not an alkylene group.

The number of carbon atoms of the alkylene group optionally having an etheric oxygen atom is preferably from 1 to 10, and particularly preferably from 2 to 6.

Q^{a6} is preferably —CH₂OCH₂CH₂CH₂—, —CH₂OCH₂CH₂OCH₂CH₂CH₂—, —CH₂CH₂—, or —CH₂CH₂CH₂— from the viewpoint of easily producing a compound (however, the right side is bonded to Z^{a}).

Z^{a} is a (w2+1)-valent organopolysiloxane residue or a (w2+1)-valent group having an alkylene group between the organopolysiloxane residue and the organopolysiloxane residue.

w2 is an integer from 2 to 7.

Examples of the (w2+1)-valent organopolysiloxane residue and the (w2+1)-valent group having an alkylene group between the organopolysiloxane residue and the organopolysiloxane residue include the following groups. However, R^{a} in the following formula is as described above. * indicates the binding site.

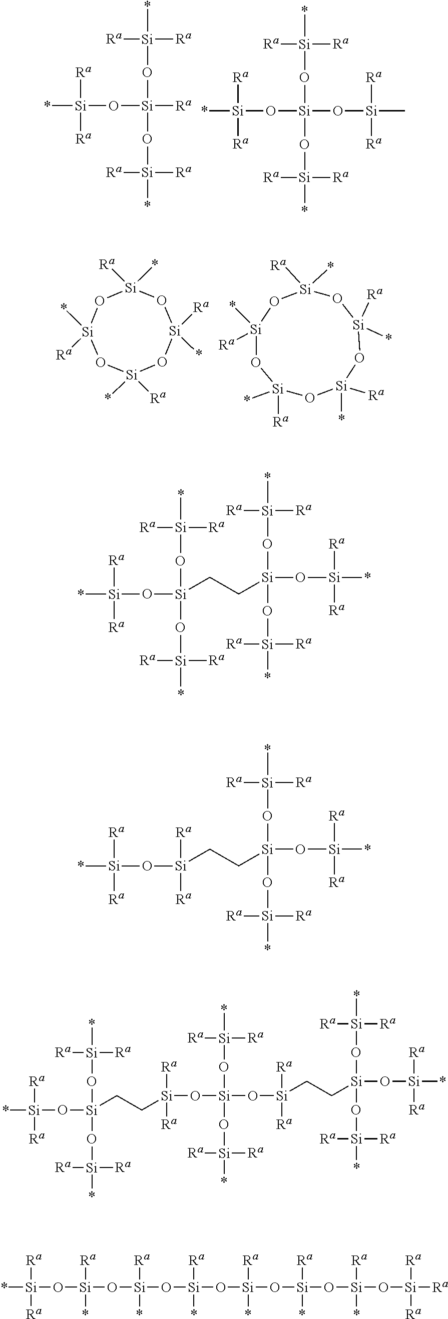

Q^{b6} is an alkylene group or a group having an etheric oxygen atom or a divalent organopolysiloxane residue between carbon-carbon atoms of the alkylene group having two or more carbon atoms.

The number of carbon atoms in the alkylene group represented by Q^{b6} is preferably from 1 to 30, more preferably from 1 to 20, still more preferably from 2 to 20, and may be from 2 to 10, from 2 to 6. Examples thereof include 2, 3, 8, 9, and 11. The number of carbon atoms may be from 1 to 10.

The number of carbon atoms of the group having an etheric oxygen atom or a divalent organopolysiloxane residue between carbon-carbon atoms of the alkylene group having two or more carbon atoms represented by Q^{b6} is preferably from 2 to 20, more preferably from 2 to 10, and still more preferably from 2 to 6.

Q^{b6} is preferably —CH₂CH₂— or —CH₂CH₂CH₂— from the viewpoint of easily producing a compound. w2 pieces of [-Q^{b}6-Si(R²)ₙL₃₋ₙ] may be the same or different from each other.

Specific examples of the Group (3-1A-6) include the following groups. In the following formula, * represents a bonding position with Z.

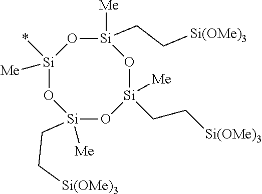

In the Group (3-1A-7), Z^{c} is a (w3+w4+1)-valent hydrocarbon group.

w3 is an integer of 4 or more.

w4 is an integer of 0 or more.

The definitions and preferred ranges of Q^{e}, s4, Q^{a4}, t4, Q^{b4}, and u4 are the same as the definitions of the respective reference numerals in the Group (3-1A-4).

Z^{c} may be composed of a hydrocarbon chain, may have an etheric oxygen atom between carbon-carbon atoms of the hydrocarbon chain, and is preferably composed of a hydrocarbon chain.

The valence of Z^{c} is preferably from pentavalent to 20 valence, more preferably from pentavalent to decavalent, still more preferably from pentavalent to octavalent, and particularly preferably from pentavalent to hexavalent.

The number of carbon atoms in Z^{c} is preferably from 3 to 50, more preferably from 4 to 40, and still more preferably from 5 to 30.

w3 is preferably from 4 to 20, more preferably from 4 to 16, still more preferably from 4 to 8, and particularly preferably from 4 to 5.

w4 is preferably from 0 to 10, more preferably from 0 to 8, still more preferably from 0 to 6, particularly preferably from 0 to 3, and most preferably from 0 to 1.

In a case in which there are two or more pieces of [—(O-Q^{b4})ᵤ₄-Si(R²)ₙL₃₋ₙ], two or more pieces of [—(O-Q^{b4})ᵤ₄-Si(R²)ₙL₃₋ₙ] may be the same or different from each other.

In a case in which the A side terminal of Z is an alkylene chain or a divalent organopolysiloxane residue, specific examples of the Group (3-1A-7) include the following group. In the following formula, * represents a bonding position with Z.

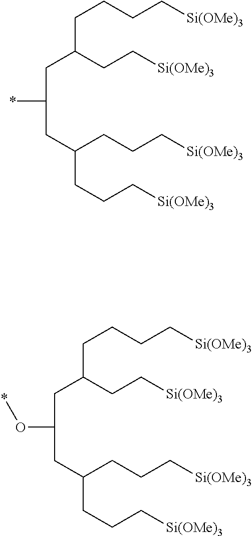

In a case in which the terminal of Z on the side of A is a polyalkylene oxide chain, specific examples of the Group (3-1A-7) include the following groups. In the following formula, * represents a bonding position with Z.

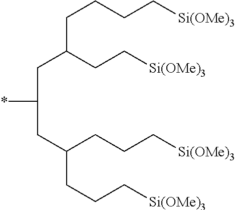

A in Formula 1 may be a Group (g2-1) (where, j1=d1+d3 and g1 =d2+d4), a Group (g2-2) (where, j1=e1 and g1=e2), a Group (g2-3) (where, j1=1 and g1=2), a Group (g2-4) (where, j1=h1 and g1=h2), a Group (g2-5) (where, j1=i1 and g1=i2), a Group (g2-6) (where, j1=1 and g1=1), or a Group (g2-7) (where j1=1 and g1=i3).

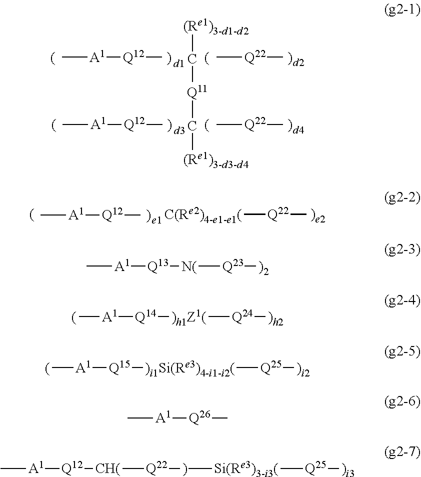

In Formulas (g2-1) to (g2-7), the A¹ side is bonded to Z, and the Q²², Q²³ Q²⁴ Q²⁵, or Q²⁶ side is bonded to [—Si(R²)ₙL₃₋ₙ]Z.

A¹ is a single bond, —C(O)NR⁶—, —C(O)—, —OC(O)O—, —NHC(O)O—, —NHC(O)NR⁶—, —O—, or SO₂NR⁶—.

Q¹¹ is a single bond, —O—, an alkylene group, or a group having —C(O)NR⁶—, —C(O)—, —NR⁶—, or —O— between carbon-carbon atoms of an alkylene group having two or more carbon atoms.

Q¹² is a single bond, an alkylene group, or a group having —C(O)NR⁶—, —C(O)—, —NR⁶—, or —O— between carbon-carbon atoms of an alkylene group having two or more carbon atoms, and when A has two or more pieces of Q¹², two or more pieces of Q¹² may be the same or different from each other.

Q¹³ is a single bond (where, A¹ is —C(O)—), an alkylene group, a group having —C(O)NR⁶—, —C(O)—, —NR⁶— or —O— between carbon-carbon atoms of an alkylene group having two or more carbon atoms, or a group having —C(O)— at an N-side terminal of an alkylene group.

Q¹⁴ is Q¹² when the atom in Z¹ to which Q¹⁴ is bonded is a carbon atom, Q¹³ when the atom in Z¹ to which Q¹⁴ is bonded is a nitrogen atom, and when A² has two or more pieces of Q¹⁴, two or more pieces of Q¹⁴ may be the same or different from each other.

Q¹⁵ is an alkylene group, or a group having —C(O)NR⁶—, —C(O)—, —NR⁶—, or —O— between carbon-carbon atoms of an alkylene group having two or more carbon atoms, and when A has two or more pieces of Q¹⁵, the two or more Q¹⁵ may be the same or different from each other.

In a case in which A¹ is a single bond, the A side terminals of Q¹¹ to Q¹⁵ are not an alkylene group.

Q²² is an alkylene group, a group having —C(O)NR⁶—, —C(O)—, —NR⁶—, or —O— between carbon-carbon atoms of an alkylene group having two or more carbon atoms, a group having —C(O)NR⁶—, —C(O)—, —NR⁶—, or —O— at a terminal of the alkylene group on a side which is not connected to Si, or a group having —C(O)NR⁶—, —C(O)—, —NR⁶—, or —O— between carbon-carbon atoms of an alkylene group having two or more carbon atoms and having —C(O)NR⁶—, —C(O)—, —NR⁶—, or —O— at a terminal on a side which is not connected to Si, and when A has two or more pieces of Q²², two or more pieces of Q²² may be the same or different from each other.

Q²³ is an alkylene group or a group having —C(O)NR⁶—, —C(O)—, —NR⁶— or —O— between carbon-carbon atoms of an alkylene group having two or more carbon atoms, and two pieces of Q² may be the same or different from each other.

Q²⁴ is Q²² when the atom in Z¹ to which Q²⁴ is bonded is a carbon atom, Q²³ when the atom in Z¹ to which Q²⁴ is bonded is a nitrogen atom, and when A has two or more pieces of Q²⁴, two or more pieces of Q²⁴ may be the same or different from each other.

Q²⁵ is an alkylene group, or a group having —C(O)NR⁶—, —C(O)—, —NR⁶—, or —O— between carbon-carbon atoms of an alkylene group having two or more carbon atoms, and when A has two or more pieces of Q²⁵, two or more pieces of Q²⁵ may be the same or different from each other.

Q²⁶ is an alkylene group, or a group having —C(O)NR⁶—, —C(O)—, —NR⁶—, or —O— between carbon-carbon atoms of an alkylene group having two or more carbon atoms.

In a case in which A¹ is a single bond, the A side terminal of Q²⁶ is not an alkylene group.

Z¹ is a group having a (h1+h2)-valent ring structure having a carbon atom or a nitrogen atom to which Q¹⁴ is directly bonded and having a carbon atom or nitrogen atom to which Q²⁴ is directly bonded.

R^{e1} is a hydrogen atom or an alkyl group, and when A has two or more pieces of R^{e1}, the two or more pieces of R^{e1} may be the same or different from each other.

R^{e2} is a hydrogen atom, a hydroxyl group, an alkyl group, or an acyloxy group.

R^{e3} is an alkyl group. R⁶ is a hydrogen atom, an alkyl group having 1 to 6 carbon atoms, or a phenyl group.

d1 is an integer from 0 to 3, and is preferably 1 or 2.

d2 is an integer from 0 to 3, and is preferably 1 or 2.

d1+d2 is an integer from 1 to 3.

d3 is an integer from 0 to 3, and is preferably 0 or 1.

d4 is an integer from 0 to 3, and is preferably 2 or 3.

d3+d4 is an integer from 1 to 3.

d1+d3 is an integer from 1 to 5, and is preferably 1 or 2.

d2+d4 is an integer from 1 to 5, and is preferably 4 or 5.

e1+e2 is 3 or 4.

e1 is an integer from 1 to 3, and is preferably 1 or 2.

e2 is an integer from 1 to 3, and is preferably 2 or 3.

h1 is an integer of 1 or more, and is preferably 1 or 2.

h2 is an integer of 1 or more, and is preferably 2 or 3.

i1+i2 is 3 or 4.

i1 is an integer from 1 to 3, and is preferably 1 or 2.
i2 is an integer from 1 to 3, and is preferably 2 or 3.
i3 is 2 or 3.

The number of carbon atoms in the alkylene group of Q¹¹, Q¹², Q¹³, Q¹⁴, Q¹⁵, Q²², Q²³, Q²⁴, Q²⁵, and Q²⁶ is preferably from 1 to 30, more preferably from 1 to 20, still more preferably from 2 to 20, may be from 2 to 10, or may be from 2 to 6 from the viewpoint of easily producing a compound and being further excellent in abrasion resistance of the surface treatment layer. Examples thereof include 2, 3, 8, 9, and 11. The number of carbon atoms may be from 1 to 10, from 1 to 6, or from 1 to 4. However, the lower limit value of the number of carbon atoms of the alkylene group is 2 in the case of having a specific bond between carbon-carbon atoms.

Examples of the ring structure in Z¹ include the ring structures described above, and preferred forms are also the same. Q¹⁴ and Q²⁴ are directly bonded to the ring structure in Z¹, and thus, for example, there is no such case where an alkylene group is linked to the ring structure and Q¹⁴ and Q²⁴ are linked to the alkylene group.

The number of carbon atoms in the alkyl group of R^{e1}, R^{e2}, or R^{e3} is preferably from 1 to 6, more preferably from 1 to 3, and particularly preferably from 1 to 2 from the viewpoint of easily producing a compound.

The number of carbon atoms in the alkyl group moiety of the acyloxy group of R^{e2} is preferably from 1 to 6, more preferably from 1 to 3, and particularly preferably from 1 to 2 from the viewpoint of easily producing a compound.

h1 is preferably from 1 to 6, more preferably from 1 to 4, still more preferably 1 or 2, and particularly preferably 1 from the viewpoint of easily producing a compound and being further excellent in abrasion resistance of the surface treatment layer.

h2 is preferably from 2 to 6, more preferably from 2 to 4, and particularly preferably 2 or 3 from the viewpoint of easily producing a compound and being further excellent in abrasion resistance of the surface treatment layer.

Other forms of A include a Group (g2-8) (where, j1=d1+d3, and g1=d2×k3+d4×k3), a Group (g2-9) (where, j1=e1 and g1=e2×k3), a Group (g2-10) (where, j1=1 and g1=2×k3), a Group (g2-11) (where, j1=h1 and g1=h2×k3), a Group (g2-12) (where, j1=i1 and g1=i2×k3), a Group (g2-13) (where, j1=1 and g1=k3), or a Group (g2-14) (where, j1=1 and g1=i3×k3).

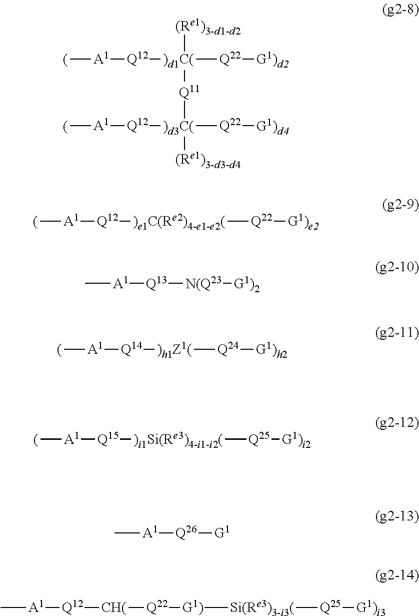

In Formulas (g2-8) to (g2-14), the A¹ side is bonded to Z, and the G¹ side is bonded to [—Si(R²)ₙL₃₋ₙ].

G¹ is the following Group (g3), and two or more pieces of G¹ of A may be the same or different from each other. The reference numerals other than G¹ are the same as the reference numerals in Formulas (g2-1) to (g2-7).

—Si(R⁸)₃₋ₖ₃(-Q³-)ₖ₃ (g3)

In the Group (g3), the Si side is connected to Q²², Q²³ Q²⁴ Q²⁵, and Q²⁶, and the Q³ side is connected to [—Si(R²)ₙL₃₋ₙ]. R⁸ is an alkyl group. Q³ is an alkylene group, a group having —C(O)NR⁶—, —C(O)—, —NR⁶— or —O— between carbon-carbon atoms of an alkylene group having two or more carbon atoms, or (OSi(R⁹)₂)ₚ—O—, and two or more pieces of Q³ may be the same or different from each other. k3 is 2 or 3. R⁶ is a hydrogen atom, an alkyl group having 1 to 6 carbon atoms, or a phenyl group. R⁹ is an alkyl group, a phenyl group, or an alkoxy group, and two pieces of R⁹ may be the same or different from each other. p is an integer from 0 to 5, and when p is two or more, two or more (OSi(R⁹)₂) may be the same or different from each other.

The number of carbon atoms in the alkylene group of Q³ is preferably from 1 to 30, more preferably from 1 to 20, still more preferably from 2 to 20, and may be from 2 to 10 or from 2 to 6 from the viewpoint of easily producing a compound and being further excellent in abrasion resistance of the surface treatment layer. Examples thereof include 2, 3, 8, 9, and 11. The number of carbon atoms may be from 1 to 10, from 1 to 6, or from 1 to 4. However, the lower limit value of the number of carbon atoms of the alkylene group is 2 in the case of having a specific bond between carbon-carbon atoms.

The number of carbon atoms in the alkyl group of R⁸ is preferably from 1 to 6, more preferably from 1 to 3, and still more preferably from 1 to 2 from the viewpoint of easily producing a compound.

The number of carbon atoms in the alkyl group of R⁹ is preferably from 1 to 6, more preferably from 1 to 3, and still more preferably from 1 to 2 from the viewpoint of easily producing a compound.

The number of carbon atoms in the alkoxy group of R⁹ is preferably from 1 to 6, more preferably from 1 to 3, and still more preferably from 1 to 2 from the viewpoint of being excellent in storage stability of the compound. p is preferably 0 or 1.

Examples of the compound of the present disclosure include a compound of the following formula. The compound of the following formula is preferable from the viewpoint of easy industrial production, easy handling, and being further excellent in water repellency and abrasion resistance of the surface treatment layer. R in the compound of the following Formula is the same as [T-(O)ᵣ—Z—] in Formula 1 described above, and preferable forms are also the same.

When the A side terminal of Z is an alkylene chain or a divalent organopolysiloxane residue, examples of the compound in which A in Formula 1 is a Group (g2-1) include a compound of the following Formula.

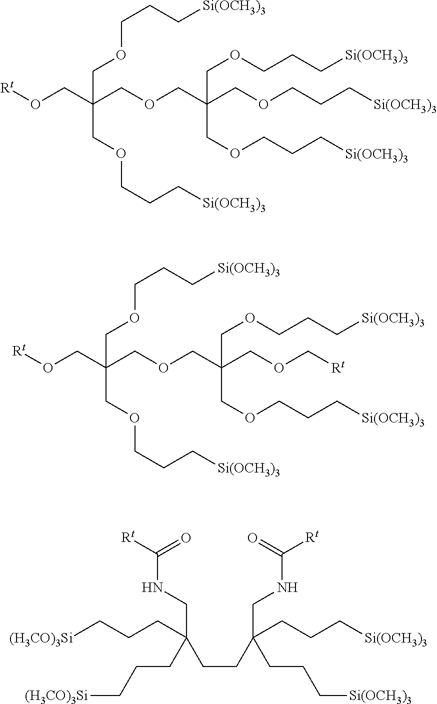

In a case in which the A side terminal of Z is a polyalkylene oxide chain, examples of the compound in which A in Formula 1 is a Group (g2-1) include a compound of the following Formula.

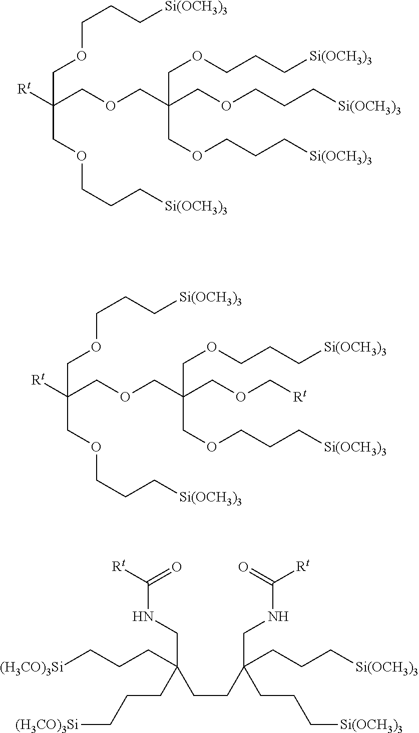

When the A side terminal of Z is an alkylene chain or a divalent organopolysiloxane residue, examples of the compound in which A in Formula 1 is a Group (g2-2) include a compound of the following Formula.

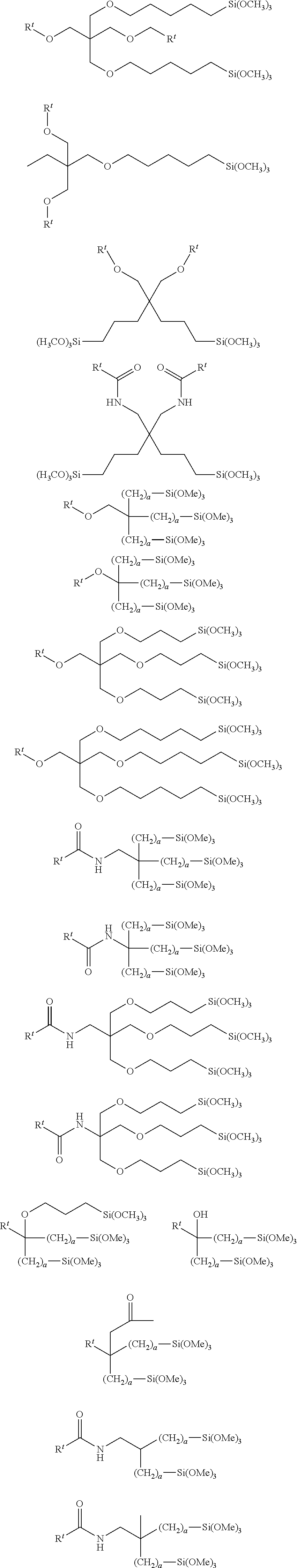

In a case in which the A side terminal of Z is a polyalkylene oxide chain, examples of the compound in which A in Formula 1 is a Group (g2-2) include a compound of the following Formula.

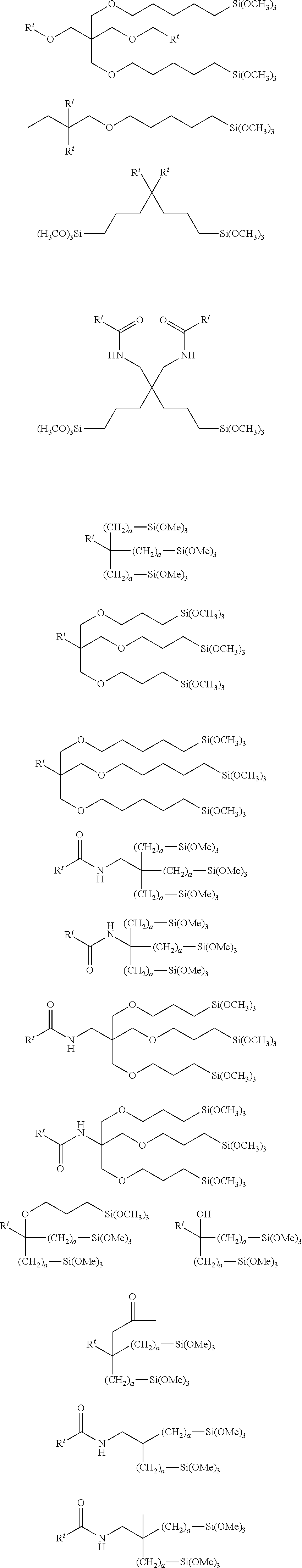

In a case in which the A side terminal of Z is an alkylene chain or a divalent organopolysiloxane residue, examples of the compound in which A in Formula 1 is a Group (g2-3) include a compound of the following Formula.

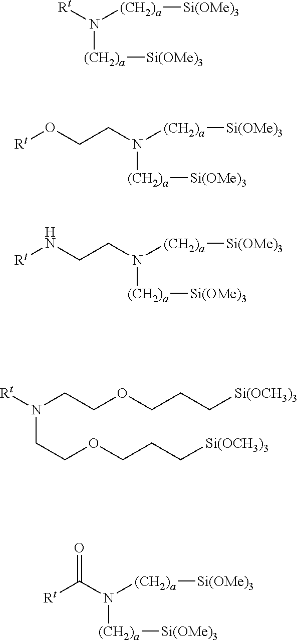

In a case in which the A side terminal of Z is a polyalkylene oxide chain, examples of the compound in which A in Formula 1 is a Group (g2-3) include a compound of the following Formula.

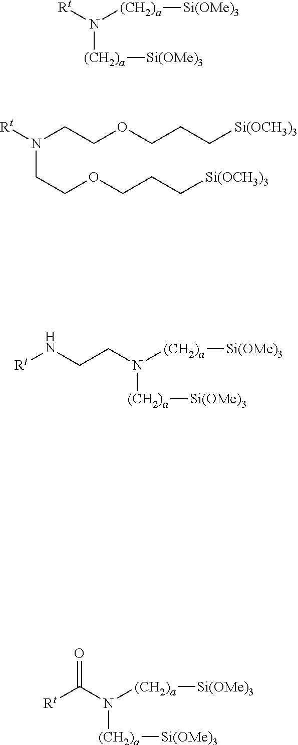

In a case in which the A side terminal of Z is an alkylene chain or a divalent organopolysiloxane residue, examples of the compound in which A in Formula 1 is a Group (g2-4) include a compound of the following Formula.

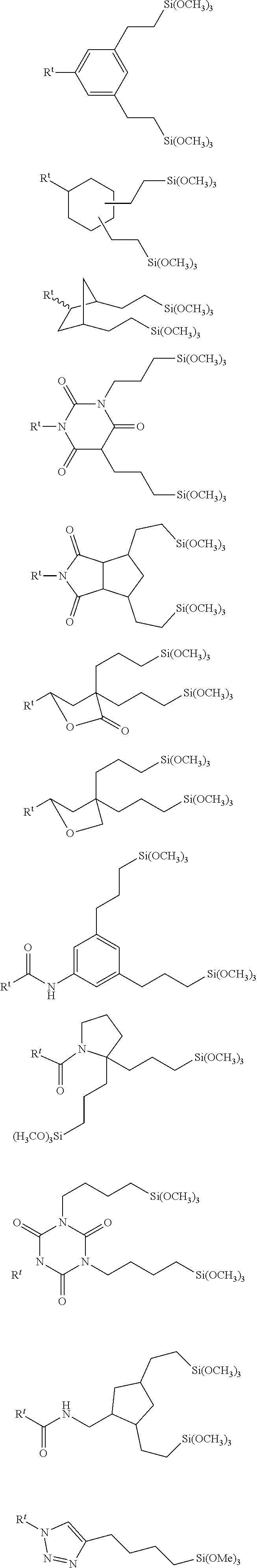

In a case in which the A side terminal of Z is a polyalkylene oxide chain, examples of the compound in which A in Formula 1 is a Group (g2-4) include a compound of the following

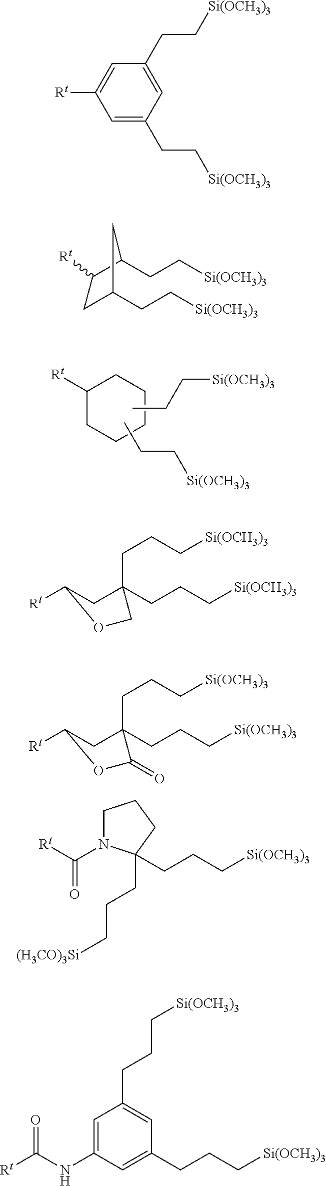

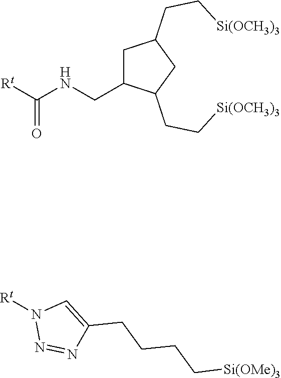

In a case in which the A side terminal of Z is an alkylene chain or a divalent organopolysiloxane residue, examples of the compound in which A in Formula 1 is a Group (g2-5) include a compound of the following Formula.

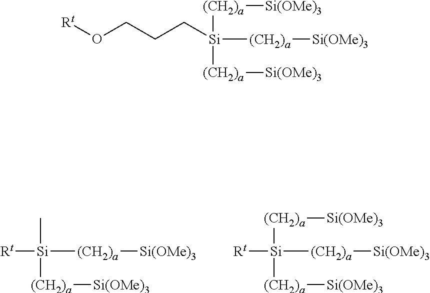

In a case in which the A side terminal of Z is a polyalkylene oxide chain, examples of the compound in which A in Formula 1 is a Group (g2-5) include a compound of the following Formula.

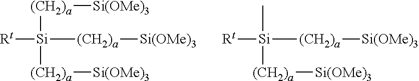

When the A side terminal of Z is an alkylene chain or a divalent organopolysiloxane residue, examples of the compound in which A in Formula 1 is a Group (g2-6) include a compound of the following Formula.

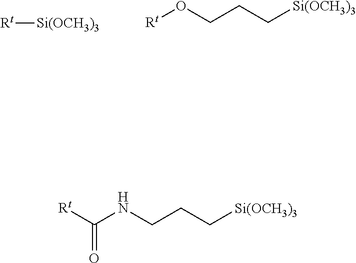

In a case in which the A side terminal of Z is a polyalkylene oxide chain, examples of the compound in which A in Formula 1 is a Group (g2-6) include a compound of the following Formula.

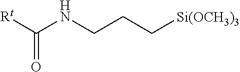

In a case in which the A side terminal of Z is an alkylene chain or a divalent organopolysiloxane residue, examples of the compound in which A in Formula 1 is a Group (g2-7) include a compound of the following Formula.

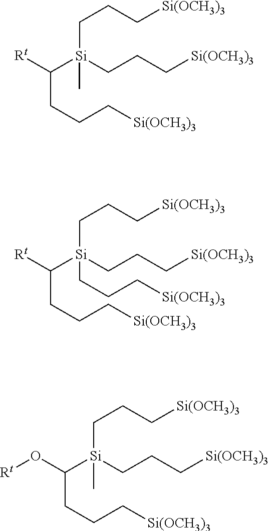

In a case in which the A side terminal of Z is a polyalkylene oxide chain, examples of the compound in which A in Formula 1 is a Group (g2-7) include a compound of the following Formula.

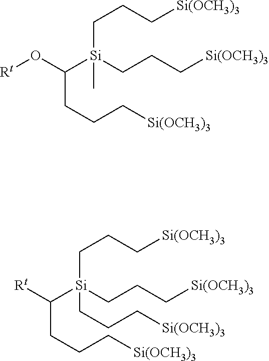

In a case in which the A side terminal of Z is an alkylene chain or a divalent organopolysiloxane residue, examples of the compound in which A in Formula 1 is a Group (g2-8) include a compound of the following Formula.

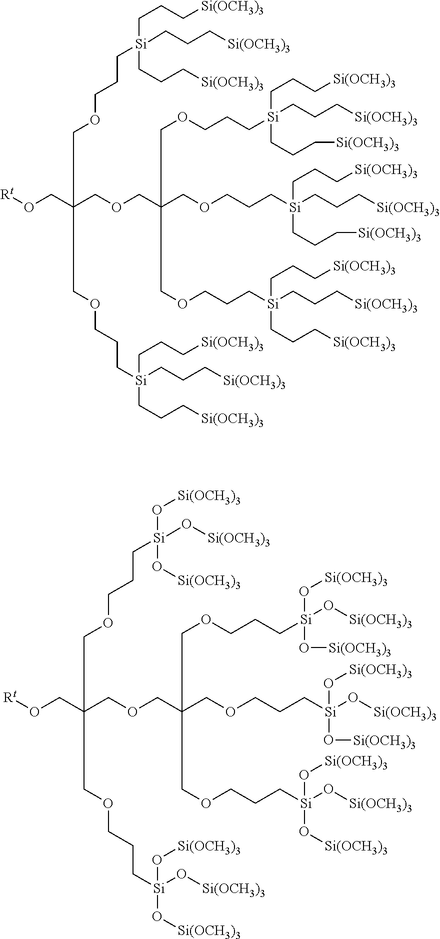

In a case in which the A side terminal of Z is a polyalkylene oxide chain, examples of the compound in which A in Formula 1 is a Group (g2-8) include a compound of the following Formula.

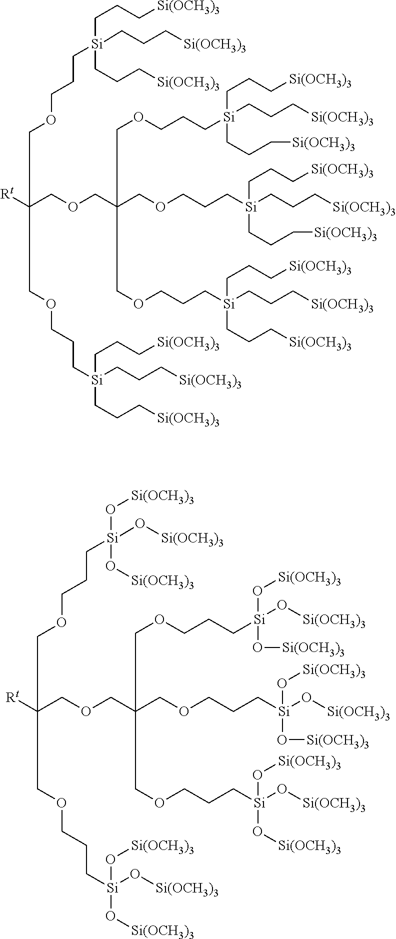

Examples of the compound in which A is a Group (g2-9) in Formula 1 include a compound of the following formula.

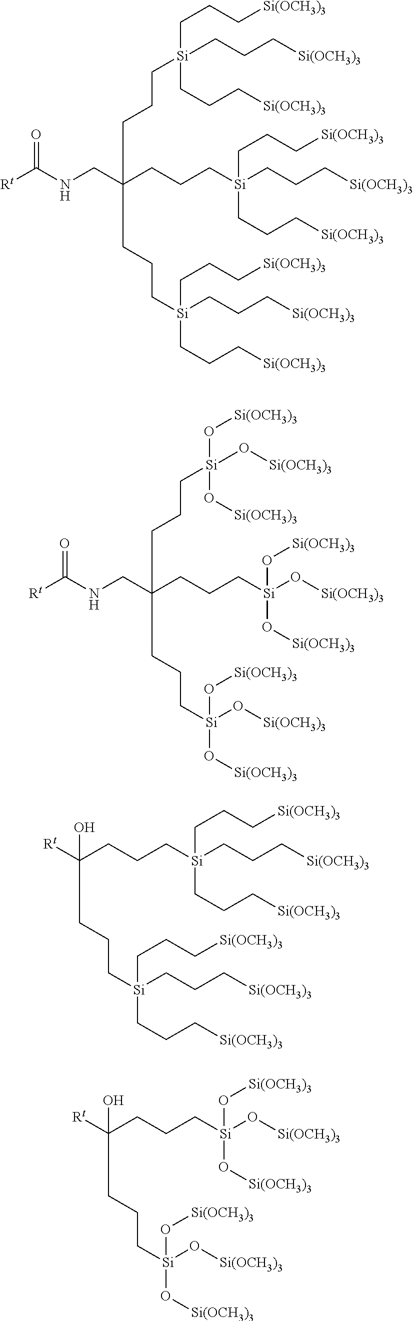

In a case in which the A side terminal of Z is an alkylene chain or a divalent organopolysiloxane residue, examples of the compound in which A in Formula 1 is a Group (g2-10) include a compound of the following Formula.

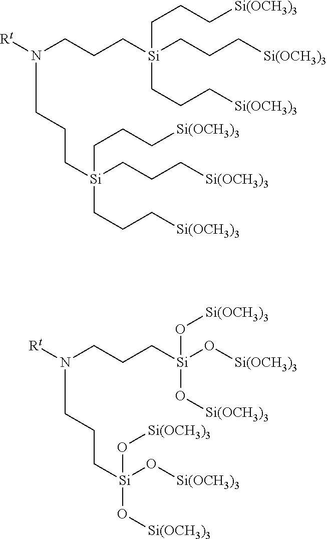

In a case in which the A side terminal of Z is a polyalkylene oxide chain, examples of the compound in which Ain Formula 1 is a Group (g2-10) include a compound of the following Formula.

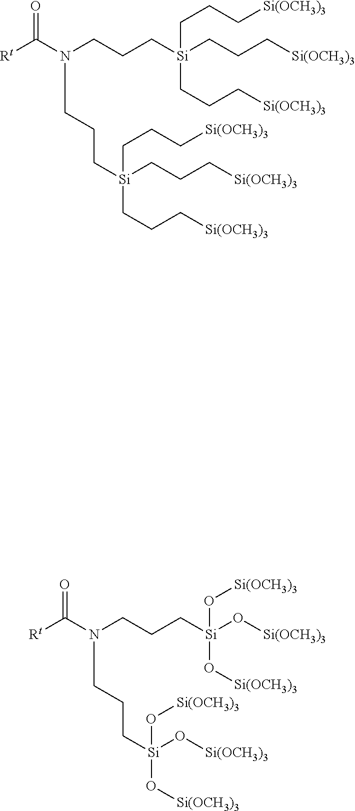

In a case in which the A side terminal of Z is an alkylene chain or a divalent organopolysiloxane residue, examples of the compound in which A in Formula 1 is a Group (g2-11) include a compound of the following Formula.

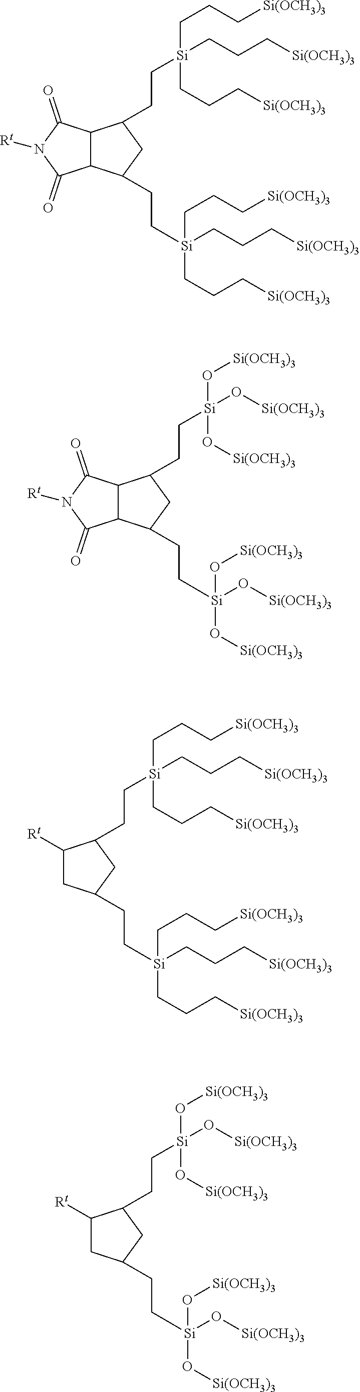

In a case in which the A side terminal of Z is a polyalkylene oxide chain, examples of the compound in which A in Formula 1 is a Group (g2-11) include a compound of the following Formula.

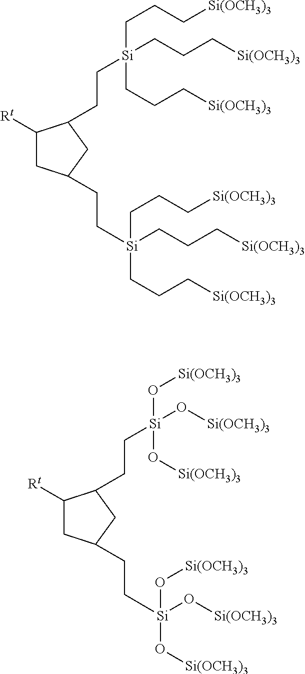

In a case in which the A side terminal of Z is an alkylene chain or a divalent organopolysiloxane residue, examples of the compound in which A in Formula 1 is a Group (g2-12) include a compound of the following Formula.

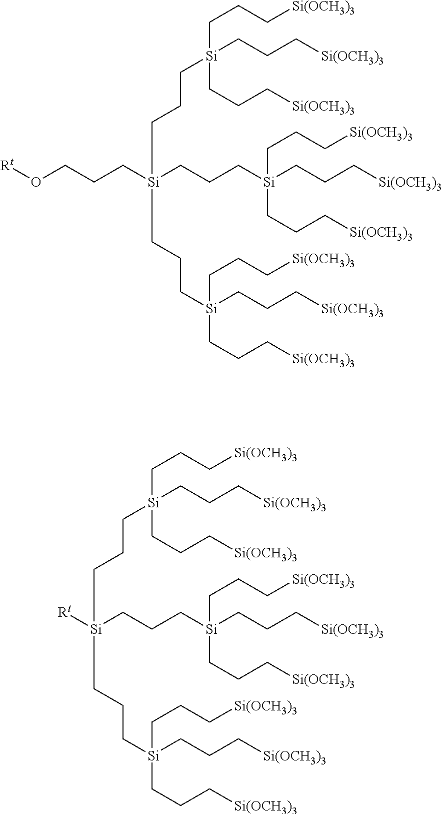

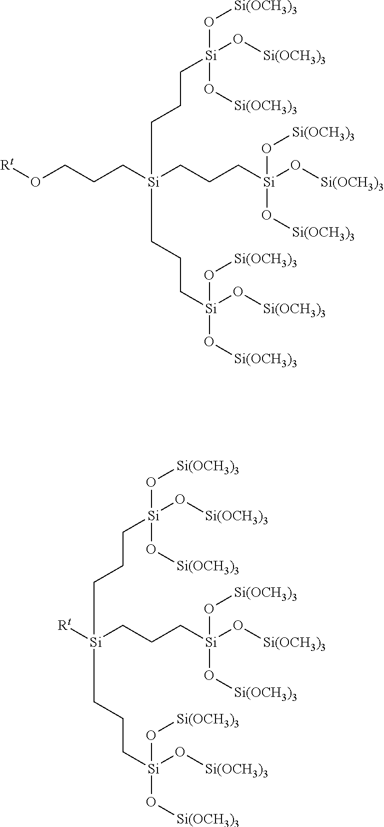

In a case in which the Aside terminal of Z is a polyalkylene oxide chain, examples of the compound in which A in Formula 1 is a Group (g2-12) include a compound of the following Formula.

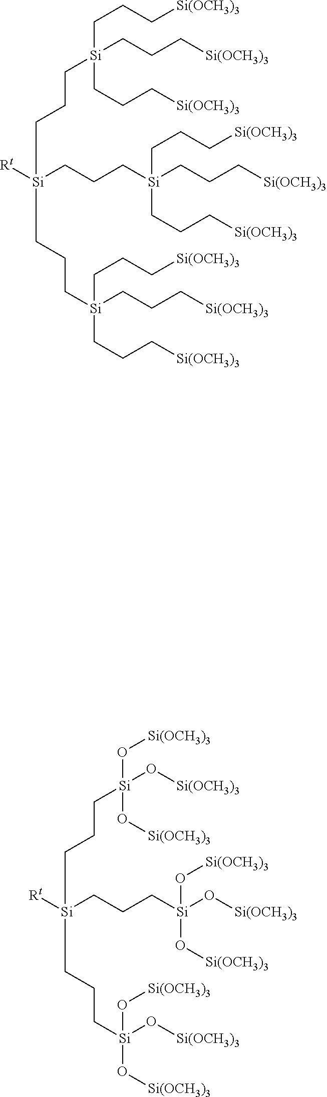

In a case in which the A side terminal of Z is an alkylene chain or a divalent organopolysiloxane residue chain, examples of the compound in which A in Formula 1 is a Group (g2-13) include a compound of the following Formula.

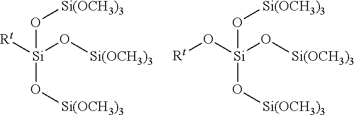

In a case in which the A side terminal of Z is a polyalkylene oxide chain, examples of the compound in which A in Formula 1 is a Group (g2-13) include a compound of the following Formula.

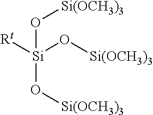

Examples of the compound in which A is a Group (g2-14) in Formula 1 include a compound of the following formula.

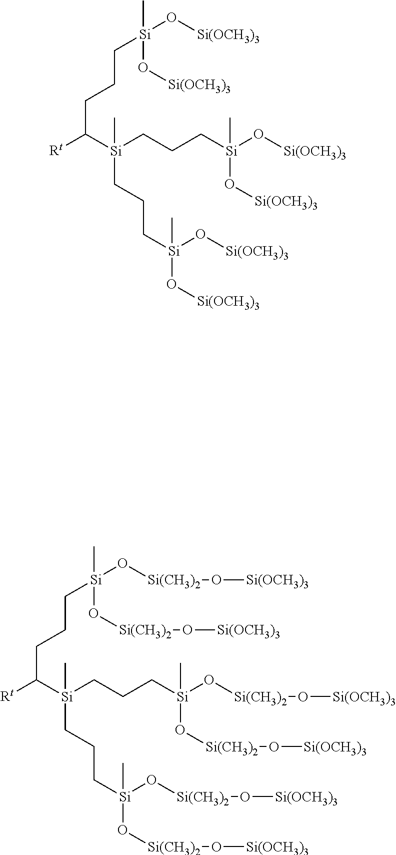

Examples of the compound of the present disclosure include the following compound. In the exemplified compounds, n is preferably from 9 to 50, more preferably from 11 to 30, and still more preferably from 11 to 25.

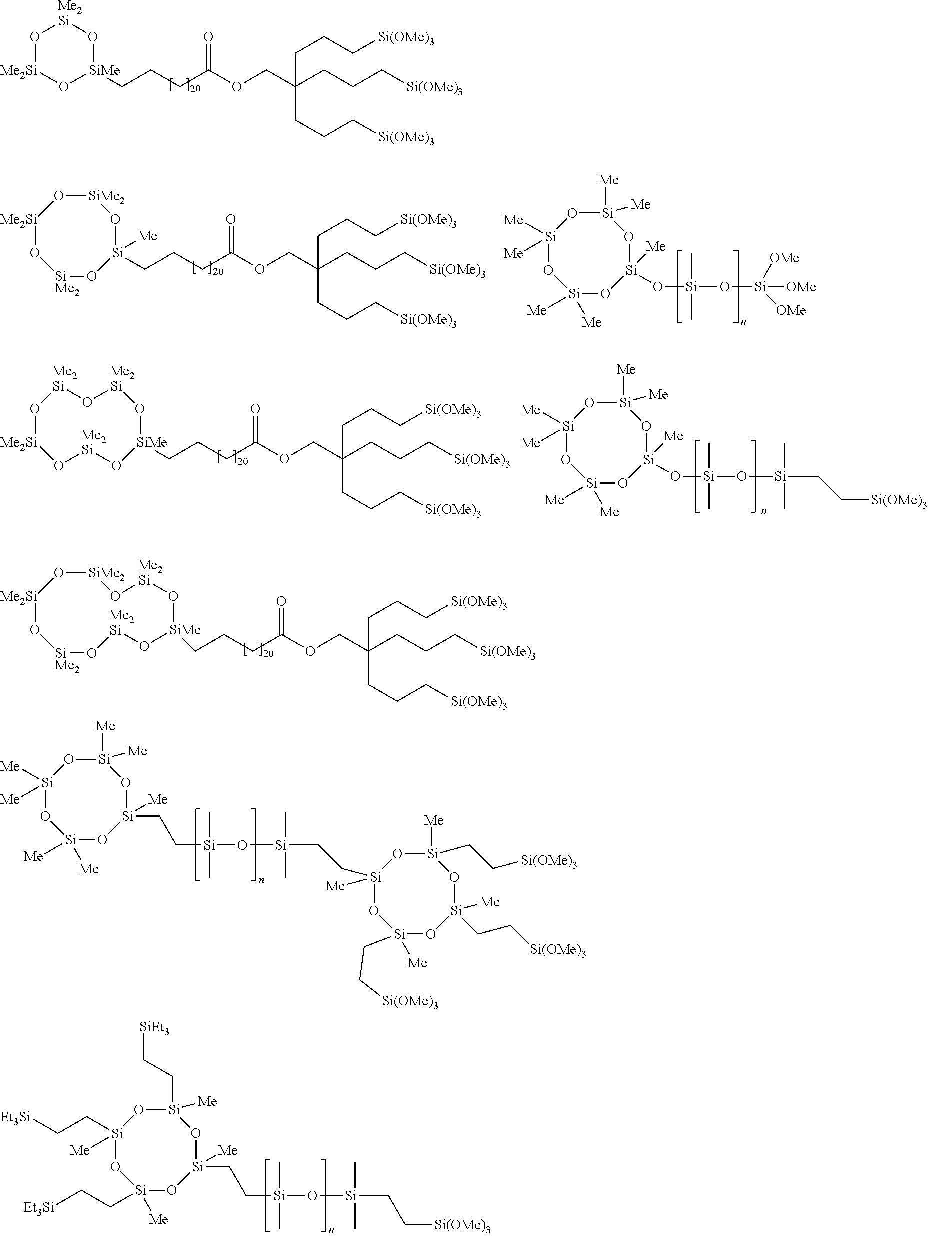

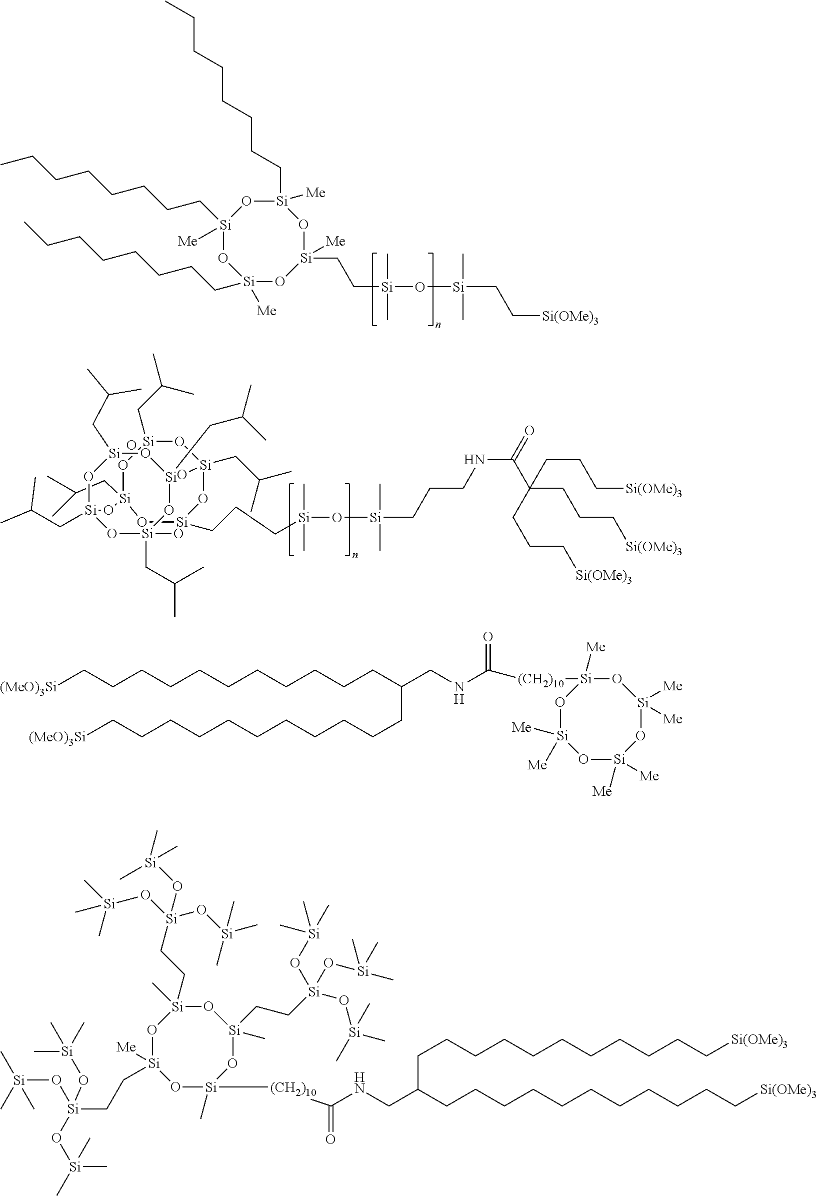

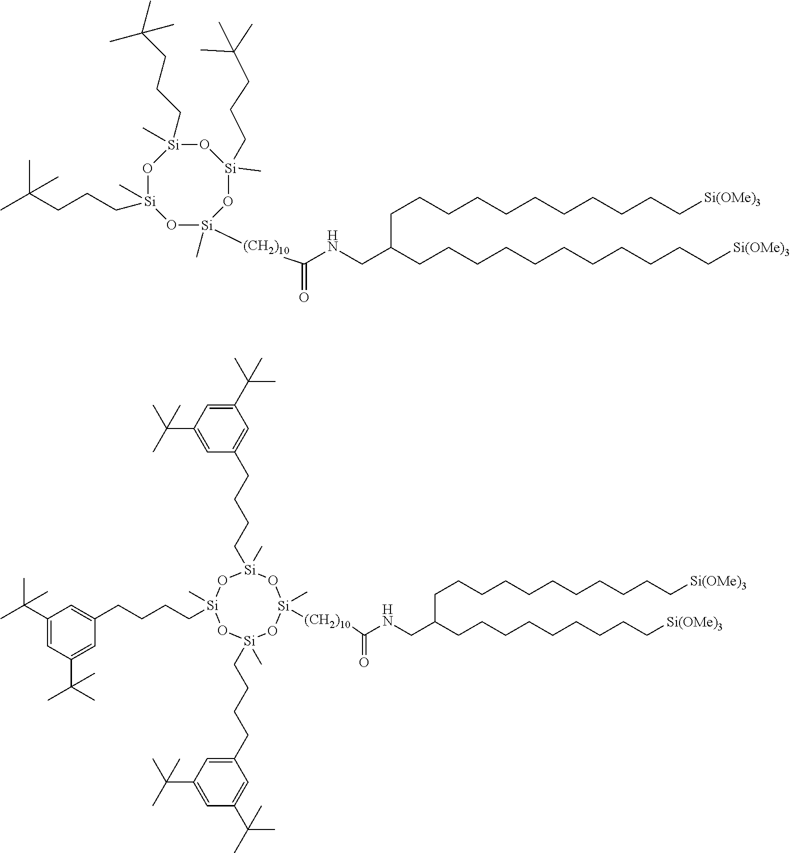

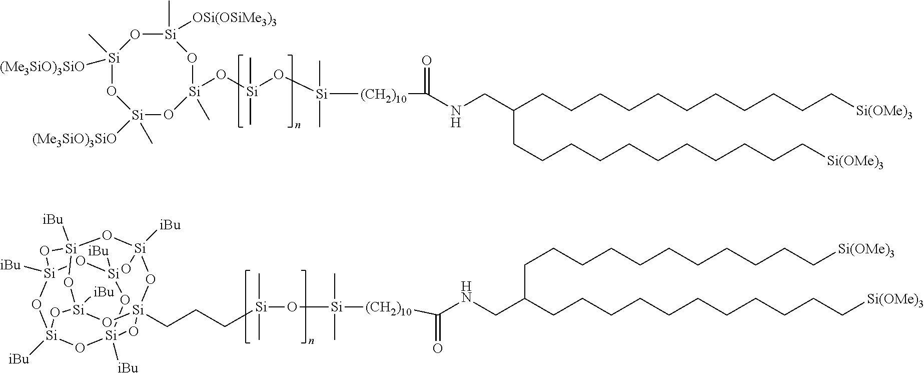

The number average molecular weight (Mn) of the compound of the present disclosure is preferably from 600 to 20,000, more preferably from 700 to 18,000, and still more preferably from 800 to 15,000.

In a case in which Mn is 600 or more, the abrasion resistance of the surface treatment layer is more excellent. When Mn is 20,000 or less, the viscosity is easily adjusted within an appropriate range, and the solubility is improved, and thus handleability at the time of film formation is excellent.

### [Composition]

The composition of the present disclosure may contain the compound of the present disclosure, and components other than the compound of the present disclosure are not particularly limited. The composition of the present disclosure preferably contains a compound of the present disclosure and a liquid medium. When the composition according to the present disclosure includes a liquid medium, the composition according to the present disclosure may be a solution, or may be a dispersion, as long as the composition is liquid.

The composition of the present disclosure may contain the compound of the present disclosure, and may contain impurities such as by-products generated in the step of producing the compound of the present disclosure.

The content rate of the compound of the present disclosure is preferably from 0.001 to 40% by mass, more preferably from 0.01 to 20% by mass, and still more preferably from 0.1 to 10% by mass with respect to the total amount of the composition of the present disclosure. In the case of the composition of the present disclosure used in the wet coating method, the content rate of the compound of the present disclosure may be from 0.01 to 10% by mass, from 0.02 to 5% by mass, from 0.03 to 3% by mass, or from 0.05 to 2% by mass with respect to the total amount of the composition of the present disclosure.

The liquid medium contained in the composition of the present disclosure may be of only one kind or two or more kinds.

The liquid medium is preferably an organic solvent.

Examples of the organic solvents include compounds composed only of hydrogen atoms and carbon atoms, and compounds composed only of hydrogen atoms, carbon atoms, and oxygen atoms, and specific examples thereof include hydrocarbon-based organic solvents, ketone-based organic solvents, ether-based organic solvents, ester-based organic solvents, glycol-based organic solvents, and alcohol-based organic solvents.

Specific examples of the hydrocarbon-based organic solvent include pentane, hexane, heptane, octane, hexadecane, isohexane, isooctane, isononane, cycloheptane, cyclohexane, bicyclohexyl, benzene, toluene, ethylbenzene, o-xylene, m-xylene, p-xylene, o-diethylbenzene, m-diethylbenzene, p-diethylbenzene, n-butylbenzene, sec-butylbenzene, and tert-butylbenzene.

Specific examples of the ketone-based organic solvent include acetone, methyl ethyl ketone, methyl isobutyl ketone, diisobutyl ketone, cyclohexanone, 2-heptanone, 4-heptanone, 3,5,5-trimethyl-2-cyclohexene-1-one, and 3,3,5-trimethylcyclohexanone, and isophorone.

Specific examples of the ether-based organic solvent include diethyl ether, cyclopentyl methyl ether, tetrahydrofuran, and 1,4-dioxane.

Specific examples of the ester-based organic solvent include methyl acetate, ethyl acetate, propyl acetate, isopropyl acetate, butyl acetate, isobutyl acetate, tert-butyl acetate, amyl acetate, isoamyl acetate, ethyl 3-ethoxypropionate, ethyl lactate ethylene glycol monobutyl ether acetate, diethylene glycol monobutyl ether acetate, propylene glycol monomethyl ether acetate, dipropylene glycol methyl ether acetate, 3-methoxy-3-methylbutyl acetate, 3-methoxybutyl acetate, propylene glycol monomethyl acetate, propylene glycol dimethyl acetate, ethylene glycol monoethyl ether acetate, ethylene glycol monomethyl ether acetate, diethylene glycol monoethyl ether acetate, cyclohexanol acetate, propylene glycol diacetate, propylene glycol monomethyl ether acetate, propylene glycol monomethyl ether propionate, propylene glycol monoethyl ether acetate, propylene glycol monobutyl ether acetate, propylene glycol monopropyl ether acetate, dipropylene glycol methyl ether acetate, 1,3-butylene glycol diacetate, 1,4-butanediol diacetate, 1,3-butylene glycol diacetate, 1,6-hexanediol diacetate, γ-butyrolactone, triacetin, and 2,2,4-trimethyl-1,3-pentanediol monoisobutyrate.

Specific examples of the glycol-based organic solvent include ethylene glycol, ethylene glycol monobutyl ether, diethylene glycol monobutyl ether, triethylene glycol monobutyl ether, tetraethylene glycol monobutyl ether, ethylene glycol monohexyl ether, diethylene glycol monohexyl ether, ethylene glycol mono-2-ethylhexyl ether, diethylene glycol mono-2-ethylhexyl ether, propylene glycol monomethyl ether, propylene glycol monoethyl ether, propylene glycol monobutyl ether, propylene glycol monopropyl ether, ethylene glycol monoisopropyl ether, ethylene glycol monoethyl ether, ethylene glycol monotert-butyl ether, ethylene glycol monopropyl ether, ethylene glycol monomethyl ether, diethylene glycol monoisopropyl ether, diethylene glycol monomethyl ether, dipropylene glycol monoethyl ether, dipropylene glycol monobutyl ether, dipropylene glycol monopropyl ether, dipropylene glycol monomethyl ether, tripropylene glycol monobutyl ether, tripropylene glycol monomethyl ether, propylene glycol monophenyl ether, 1,3-butylene glycol, propylene glycol n-propyl ether, propylene glycol n-butyl ether, diethylene glycol monoethyl ether, dipropylene glycol n-propyl ether, dipropylene glycol n-butyl ether, tripropylene glycol methyl ether, tripropylene glycol n-butyl ether, ethylene glycol dimethyl ether, ethylene glycol diethyl ether, ethylene glycol dibutyl ether, diethylene glycol diethyl ether, diethylene glycol dimethyl ether, dipropylene glycol dimethyl ether, diethylene glycol dibutyl ether, tetraethylene glycol dimethyl ether, dipropylene glycol dimethyl ether pentane, triethylene glycol dimethyl ether, and polyethylene glycol dimethyl ether.

Specific examples of the alcohol-based organic solvent include methanol, ethanol, 1-propanol, isopropyl alcohol, n-butanol, diacetone alcohol, isobutanol, sec-butanol, tert-butanol, pentanol, 3-methyl-1,3-butanediol, 1,3-butanediol, 1,3-butylene glycol, octanediol, 2,4-diethylpentanediol, butylethylpropanediol, 2-methyl-1,3-propanediol, 4-hydroxy-4-methyl-2-pentanone, 2-ethyl-1-hexanol, 3,5,5-trimethyl-1-hexanol, isodecanol, isotridecanol, 3-methoxy-3-methyl-1-butanol, 2-methoxybutanol, 3-methoxybutanol, cyclohexanol, furfuryl alcohol, tetrahydrofurfuryl alcohol, benzyl alcohol, and methylcyclohexanol.

Examples of the organic solvents include halogen-based organic solvents, nitrogen-containing compounds, sulfur-containing compounds, and siloxane compounds.

Specific examples of the halogen-based organic solvent include dichloromethane, chloroform, carbon tetrachloride, dichloroethane, chlorobenzene, o-chlorotoluene, m-chlorotoluene, p-chlorotoluene, m-dichlorobenzene, and 1,2,3-trichloropropane.

Examples of the nitrogen-containing compound include nitrobenzene, acetonitrile, benzonitrile, N,N-dimethylformamide, N,N-dimethylacetamide, N-methylpyrrolidone, and 1,3-dimethyl-2-imidazolidinone.

Examples of the sulfur-containing compound include carbon disulfide and dimethyl sulfoxide.

Examples of the siloxane compound include hexamethyldisiloxane, octamethyltrisiloxane, and decamethyltetrasiloxane.

The content rate of the liquid medium is preferably from 60 to 99.999% by mass, more preferably from 80 to 99.99% by mass, and still more preferably from 90 to 99.9% by mass with respect to the total amount of the composition of the present disclosure. In the case of the composition of the present disclosure used in the wet coating method, the content rate of the liquid medium may be from 90 to 99.99% by mass, from 95 to 99.98% by mass, from 97 to 99.97% by mass, or from 98 to 99.95% by mass with respect to the total amount of the composition of the present disclosure.

The composition of the present disclosure may contain other components in addition to the compound of the present disclosure and the liquid medium as long as the effects of the present disclosure are not impaired.

Examples of other components include known additives such as acid catalysts and basic catalysts that promote hydrolysis and condensation reaction of reactive silyl groups.

In addition, examples of other components include metal compounds having hydrolyzable groups (hereinafter, the metal compound having a hydrolyzable group is also referred to as “specific metal compound”). The composition of the present disclosure contains a specific metal compound, thereby allowing to further improve slippage and antifouling properties of the surface treatment layer. Examples of the specific metal compound include the following formulas (M1) to (M3).

M(X^{b1})ₘ₁(X^{b2})ₘ₂(X^{b3})ₘ₃ (M1)

Si(X_{b4})(X^{b5})₃ (M2)

(X^{b6})₃Si—(Y^{b1})—Si(X^{b7})₃ (M3)

In Formula (M1),
M represents a trivalent or tetravalent metal atom.
Each X^{b1} independently represents a hydrolyzable group.
Each X^{b2} independently represents a siloxane backbone-containing group.
Each X^{b3} independently represents a hydrocarbon chain-containing group.
m1 represents an integer from 2 to 4,
each of m2 and m3 independently represents an integer from 0 to 2,
when M is a trivalent metal atom, m1+m2+m3 is 3, and when M is a tetravalent metal atom, m1+m2+m3 is 4.
In Formula (M2),
X^{b4} represents a hydrolyzable silane oligomer residue.
X^{b5} each independently represents a hydrolyzable group or an alkyl group having 1 to 4 carbon atoms.

In Formula (M3),
Each of X^{b6} and X^{b7} independently represents a hydrolyzable group or a hydroxyl group.
Y^{b1} represents a divalent organic group.

In Formula (M1), the metal represented by M also includes metalloids such as Si and Ge. M is preferably a trivalent metal or a tetravalent metal, more preferably Al, Fe, In, Hf, Si, Ti, Sn, and Zr, still more preferably Al, Si, Ti, and Zr, and particularly preferably Si.

Examples of the hydrolyzable group represented by X^{b1} in Formula (M1) include the same group as the hydrolyzable group represented by L in [—Si(R²)ₙL₃₋ₙ] in the reactive silyl group.

The siloxane backbone-containing group represented by X^{b2} has a siloxane unit (—Si—O—), and may be linear or branched. The siloxane unit is preferably a dialkylsilyloxy group, and examples thereof include a dimethylsilyloxy group and a diethylsilyloxy group. The number of repetitions of the siloxane unit in the siloxane backbone-containing group is 1 or more, preferably from 1 to 5, more preferably from 1 to 4, and still more preferably from 1 to 3.

The siloxane backbone-containing group may contain a divalent hydrocarbon group in a portion of the siloxane backbone. Specifically, some oxygen atoms of the siloxane backbone may be replaced by divalent hydrocarbon groups. Examples of the divalent hydrocarbon groups include alkylene groups such as a methylene group, an ethylene group, a propylene group, and a butylene group.

A hydrolyzable group, a hydrocarbon group (preferably an alkyl group), or the like may be bonded to the silicon atom at the end of the siloxane backbone-containing group.

The number of elements of the siloxane backbone-containing group is preferably 100 or less, more preferably 50 or less, still more preferably 30 or less. The number of elements is preferably 10 or more.

The siloxane backbone-containing group is preferably a group represented by *—(O—Si(CH₃)₂)ₙCH₃, where n represents an integer from 1 to 5, and * represents a bonding site with an adjacent atom.

The hydrocarbon chain-containing group represented by X³ may be a group consisting only of a hydrocarbon chain, or may be a group having an etheric oxygen atom between carbon-carbon atoms of the hydrocarbon chain. The hydrocarbon chain may be linear or branched, and is preferably linear. The hydrocarbon chain may be a saturated hydrocarbon chain or an unsaturated hydrocarbon chain, and is preferably a saturated hydrocarbon chain. The number of carbon atoms in the hydrocarbon chain-containing group is preferably from 1 to 3, more preferably from 1 to 2, and still more preferably 1. The hydrocarbon chain-containing group is preferably an alkyl group, and more preferably a methyl group, an ethyl group, or a propyl group.

m1 is preferably 3 or 4.

As the compound represented by Formula (M1), compounds represented by the following formulas (M1-1) to (M1-5) in which M is Si are preferable, and a compound represented by Formula (M1-1) is more preferable. The compound represented by Formula (M1-1) is preferably tetraethoxysilane, tetramethoxysilane, or triethoxymethylsilane.

Si(X^{b1})₄ (M1-1)

CH₃—Si(X^{b1})₃ (M1-2)

C₂H₅—Si(X^{b1})₃ (M1-3)

n-C₃H₇—Si(X^{b1})₃ (M1-4)

(CH₃)₂CH—Si(X^{b1})₃ (M1-5)

In Formula (M2), the number of silicon atoms contained in the hydrolyzable silane oligomer residue represented by X^{b4} is preferably 3 or more, more preferably 5 or more, still more preferably 7 or more. The number of the silicon atoms is preferably 15 or less, more preferably 13 or less, still more preferably 10 or less.

The hydrolyzable silane oligomer residue may have an alkoxy group bonded to a silicon atom. Examples of the alkoxy group include a methoxy group, an ethoxy group, a propoxy group, and a butoxy group, and a methoxy group and an ethoxy group are preferable. The hydrolyzable silane oligomer residue may have one kind or two or more kinds of these alkoxy groups, and preferably has one kind.

Examples of the hydrolyzable silane oligomer residue include (C₂H₅O)₃Si—(OSi(OC₂H₅)₂)₄O—* where * represents a binding site with an adjacent atom.

Examples of the hydrolyzable group represented by X^{b5} in Formula (M2) include the same group as the hydrolyzable group represented by L in [—Si(R²)ₙL₃₋ₙ] in the reactive silyl group, a cyano group, a hydrogen atom, and an allyl group, and an alkoxy group or an isocyanato group is preferable. The alkoxy group is preferably an alkoxy group having 1 to 4 carbon atoms.

X^{b5} is preferably a hydrolyzable group.

Examples of the compound represented by Formula (M2) include (H₅C₂O)₃—Si—(OSi(OC₂H₅)₂)₄OC₂H₅.

The compound represented by Formula (M3) is a compound having reactive silyl groups at both terminals of a divalent organic group, that is, bissilane.

Examples of the hydrolyzable group represented by X^{b6} and X^{b7} in Formula (M3) include an alkoxy group, an acyloxy group, a ketoxime group, an alkenyloxy group, an amino group, an aminoxy group, an amide group, an isocyanato group, and a halogen atom, and an alkoxy group and an isocyanato group are preferable. As the alkoxy group, an alkoxy group having 1 to 4 carbon atoms is preferable, and a methoxy group and an ethoxy group are more preferable.

In Formula (M3), X^{b6} and X^{b7} may be the same group or different groups from each other. From the viewpoint of availability, X^{b6} and X^{b7} are preferably the same group.

In Formula (M3), Y^{b1} is a divalent organic group linking reactive silyl groups at both terminals. The number of carbon atoms in Y^{b1} of the divalent organic group is preferably from 1 to 8, and more preferably from 1 to 3.

Examples of Y^{b1} include an alkylene group, a phenylene group, and an alkylene group having an etheric oxygen atom between carbon atoms. Examples thereof include —CH₂CH₂—, —CH₂CH₂CH₂—, —CH₂CH₂CH₂CH₂—, —CH₂CH₂CH₂CH₂CH₂—, —CH₂CH₂CH₂CH₂CH₂CH₂—, —CH₂C(CH₃)₂CH₂—, —C(CH₃)₂CH₂CH₂C(CH₃)₂—, —CH₂CH₂O CH₂CH₂—, —CH₂CH₂CH₂O CH₂CH₂CH₂—, —CH(CH₃)CH₂O CH₂CH(CH₃)—, and —C₆H₄—.

Examples of the compound represented by Formula (M3) include (CH₃O)₃Si(CH₂)₂Si(OCH₃)₃, (C₂H₅O)₃Si(CH₂)₂Si(OC₂H₅)₃, (OCN)₃Si(CH₂)₂Si(NCO)₃, Cl₃Si(CH₂)₂SiCl₃, (CH₃O)₃Si(CH₂)₆Si(OCH₃)₃, and (C₂H₅O)₃Si(CH₂)₆Si(OC₂H₅)₃.

The content rate of other components that may be contained in the composition of the present disclosure is preferably 10% by mass or less, and more preferably 1% by mass or less, with respect to the total amount of the composition of the present disclosure. When the composition of the present disclosure contains the specific metal compound, the content rate of the specific metal compound is preferably from 0.01 to 30% by mass, more preferably from 0.01 to 10% by mass, and still more preferably from 0.05 to 5% by mass with respect to the total amount of the composition of the present disclosure.

The total content rate (hereinafter, also referred to as “solid content concentration”) of the compound of the present disclosure and other components is preferably from 0.001 to 40% by mass, more preferably from 0.01 to 20% by mass, and still more preferably from 0.1 to 10% by mass with respect to the total amount of the composition of the present disclosure. The solid content concentration of the composition of the present disclosure is a value calculated from the mass of the composition before heating and the mass after heating in a convection dryer at 120° C. for 4 hours.

The composition of the present disclosure contains a liquid medium, and thus it is useful as a coating application and can be used as a coating liquid.

### [Surface Treatment Agent]

In one aspect, the surface treatment agent of the present disclosure includes a compound of the present disclosure. In addition, the surface treatment agent of the present disclosure may contain the compound of the present disclosure and a liquid medium. The surface treatment agent of the present disclosure may be the composition of the present disclosure. Preferable aspects of the liquid medium contained in the surface treatment agent of the present disclosure are the same as the preferable aspects of the liquid medium contained in the composition of the present disclosure.

The compound according to the present disclosure comprises the above Group 1, a partial structure that is an alkylene chain, a polyalkylene oxide chain, a divalent organopolysiloxane residue, or a combination thereof, and the above Group 2. Therefore, using a surface treatment agent containing the compound of the present disclosure allows forming a surface treatment layer excellent in water repellency and abrasion resistance.

### [Article]

In one aspect, an article of the present disclosure includes a substrate; and a surface treatment layer disposed on the substrate and formed by surface treatment with the surface treatment agent of the present disclosure.

The surface treatment layer may be formed on a portion of the surface of the substrate, or may be formed on the entire surface of the substrate. The surface treatment layer may spread in a film shape on the surface of the substrate, or may be scattered in a dot shape.

In the surface treatment layer, the compound of the present disclosure is included in a state in which hydrolysis of a portion or all of the reactive silyl group has progressed and a dehydration condensation reaction of the silanol group has progressed.

The thickness of the surface treatment layer is preferably from 1 to 100 nm, and more preferably from 1 to 50 nm. When the thickness of the surface treatment layer is 1 nm or more, the effect of the surface treatment is easily sufficiently obtained. When the thickness of the surface treatment layer is 100 nm or less, utilization efficiency is high. The thickness of the surface treatment layer can be calculated from the vibration period of the interference pattern by obtaining the interference pattern of the reflected X-ray by the X-ray reflectance method with an X-ray diffractometer for thin film analysis (product name “ATX-G”, manufactured by RIGAKU Corporation).

The kind of the substrate is not particularly limited, and examples thereof include a substrate required to be imparted with water repellency. As the substrate, for example, a substrate that may be used by being brought into contact with another article (for example, a stylus) or a human finger; a substrate that is hung by human fingers during operation; and a substrate that may be placed on other articles (for example, a placing table).

Examples of the material of the substrate include metal, resin, glass, sapphire, ceramic, stone, fiber, nonwoven fabric, paper, wood, natural leather, artificial leather, and composite materials thereof. The glass may be chemically strengthened.

Examples of the substrates include building materials, decorative building materials, interior goods, transportation equipment (for example, automobiles), signboards, bulletin boards, drinking vessels, tableware, water tanks, ornamental instruments (for example, frames, boxes), laboratory instruments, furniture, textile products, and packaging containers; glass or resin used for art, sports, games, or the like; and glass or resin used for exterior portions (excluding a display unit) in a device such as a mobile phone (for example, a smartphone), a portable information terminal, a game machine, or a remote controller. The shape of the substrate may be a plate shape or a film shape.

As the substrate, a substrate for a touch panel, a substrate for a display, and a spectacle lens are suitable, and a substrate for a touch panel is particularly suitable. The material of the substrate for a touch panel is preferably glass or a transparent resin.

The substrate may be a substrate having one surface or both surfaces subjected to a surface treatment such as a corona discharge treatment, a plasma treatment, or a plasma graft polymerization treatment. The substrate subjected to the surface treatment is more excellent in adhesion of the surface treatment layer, and the abrasion resistance of the surface treatment layer is further improved. Therefore, it is preferable to subject the surface of the substrate on the side in contact with the surface treatment layer to surface treatment. The substrate subjected to the surface treatment, when an underlayer described later is provided, has more excellent adhesion to the underlayer, and the abrasion resistance of the surface treatment layer is further improved. Therefore, when the underlayer is provided, it is preferable to subject the surface of the substrate on the side in contact with the underlayer to the surface treatment.

The surface treatment layer may be provided directly on the surface of the substrate, or the underlayer may be provided between the substrate and the surface treatment layer. From the viewpoint of further improving the water repellency and abrasion resistance of the surface treatment layer, the article of the present disclosure preferably includes a substrate, an underlayer disposed on the substrate, and a surface treatment layer disposed on the underlayer and surface-treated with the surface treatment agent of the present disclosure.

The underlayer is preferably a layer containing an oxide containing silicon and at least one specific element selected from the group consisting of a Group 1 elements, a Group 2 elements, a Group 4 elements, a Group 5 elements, a Group 13 elements, and a Group 15 elements of the periodic table.

The Group 1 elements in the periodic table (hereinafter, also referred to as “Group 1 elements”) is lithium, sodium, potassium, rubidium, and cesium. As the Group 1 elements, lithium, sodium, and potassium are preferable, and sodium and potassium are more preferable from the viewpoint that the surface treatment layer can be more uniformly formed on the underlayer without defects, or the variation in the composition of the underlayer between samples is further suppressed. The underlayer may contain two or more kinds of the Group 1 elements.

The Group 2 elements in the periodic table (hereinafter, also referred to as “Group 2 elements”) is beryllium, magnesium, calcium, strontium, and barium. As the Group 2 elements, magnesium, calcium, and barium are preferable, and magnesium and calcium are more preferable from the viewpoint that the surface treatment layer can be more uniformly formed on the underlayer without defects, or the variation in the composition of the underlayer between samples is further suppressed. The underlayer may contain two or more kinds of Group 2 elements.

The Group 4 elements in the periodic table (hereinafter, also referred to as “Group 4 elements”) is titanium, zirconium, and hafnium. As the Group 4 elements, titanium and zirconium are preferable, and titanium is more preferable from the viewpoint that the surface treatment layer can be more uniformly formed on the underlayer without defects, or from the viewpoint that variations in the composition of the underlayer between samples are further suppressed. The underlayer may contain two or more kinds of Group 4 elements.

The Group 5 elements in the periodic table (hereinafter, also referred to as “Group 5 elements”) is vanadium, niobium, and tantalum. As the Group 5 elements, vanadium is particularly preferable from the viewpoint of more excellent abrasion resistance of the surface treatment layer. The underlayer may contain two or more kinds of Group 5 elements.

The Group 13 elements in the periodic table (hereinafter, also referred to as “Group 13 elements”) is boron, aluminum, gallium, and indium. As the Group 13 elements, boron, aluminum, and gallium are preferable, and boron and aluminum are more preferable from the viewpoint that the surface treatment layer can be more uniformly formed on the underlayer without defects or the variation in the composition of the underlayer between samples is further suppressed. The underlayer may contain the two or more kinds of Group 13 elements.

The Group 15 elements in the periodic table (hereinafter, also referred to as “Group 15 elements”) is nitrogen, phosphorus, arsenic, antimony, and bismuth. As a Group 15 elements, phosphorus, antimony, and bismuth are preferable, and phosphorus and bismuth are more preferable, from the viewpoint that the surface treatment layer can be more uniformly formed on the underlayer without defects, or from the viewpoint that variation in the composition of the underlayer between samples is further suppressed. The underlayer may contain two or more kinds of Group 15 elements.

As the specific element contained in the underlayer, a Group 1 elements, a Group 2 elements, and a Group 13 elements are preferable because the abrasion resistance of the surface treatment layer is more excellent, and a Group 1 elements and a Group 2 elements are more preferable, and a Group 1 elements is still more preferable.

As the specific element, only one kind of element may be contained, or two or more kinds of elements may be contained.

An oxide contained in the underlayer may be a mixture of oxides of the above elements (silicon and specific elements) singly (for example, a mixture of a silicon oxide and an oxide of a specific element), a composite oxide containing two or more kinds of the above elements, or a mixture of an oxide of the above elements singly and a composite oxide.

The ratio of the total molar concentration of the specific element in the underlayer to the molar concentration of silicon in the underlayer (specific element/silicon) is preferably from 0.02 to 2.90, more preferably from 0.10 to 2.00, and still more preferably from 0.20 to 1.80 from the viewpoint of being more excellent in abrasion resistance of the surface treatment layer.

The molar concentration (mol %) of each element in the underlayer can be measured by, for example, depth direction analysis by X-ray photoelectron spectroscopy (XPS) with ion sputtering.

The underlayer may be a single layer or a multilayer. The underlayer may have irregularities on the surface.

The thickness of the underlayer is preferably from 1 to 100 nm, more preferably from 1 to 50 nm, and still more preferably from 2 to 20 nm. When the thickness of the underlayer is the above lower limit value or more, the adhesion of the surface treatment layer by the underlayer is further improved, and the abrasion resistance of the surface treatment layer is further excellent. When the thickness of the underlayer is the above upper limit value or less, the abrasion resistance of the underlayer itself is excellent.

The thickness of the underlayer is measured by observing a cross-section of the underlayer with a transmission electron microscope (TEM).

The underlayer can be formed by, for example, a vapor deposition method with a vapor deposition material or a wet coating method.

The vapor deposition material used in the vapor deposition method preferably contains silicon and an oxide containing a specific element.

Specific examples of the form of the vapor deposition material include a powder, a melt, a sintered body, a granulated body, and a crushed body, and from the viewpoint of handleability, the melt, the sintered body, and the granulated body are preferable.

The melt body is a solid obtained by melting a powder of the vapor deposition material at a high temperature and then cooling and solidifying the powder. The sintered body is a solid obtained by firing a powder of the vapor deposition material, and a molded body obtained by press-molding the powder may be used instead of the powder of the vapor deposition material as necessary. The granulated body is a solid obtained by kneading a powder of a vapor deposition material and a liquid medium (for example, water or an organic solvent) to provide particles and then drying the particles.

The deposition material can be produced, for example, by the following method.
A method of mixing a powder of silicon oxide and a powder of an oxide of a specific element to provide a powder of a vapor deposition material.
A method of kneading the powder of the vapor deposition material and water to provide particles, and then drying the particles to provide a granulated body of the vapor deposition material.
A method of drying a mixture obtained by mixing a powder containing silicon (for example, a powder made of a silicon oxide, silica sand, or silica gel), a powder containing a specific element (for example, a powder of an oxide of a specific element, a carbonate, a sulfate, a nitrate, an oxalate, or a hydroxide), and water, and then firing the dried mixture or a molded body obtained by press-molding the dried-mixture to provide a sintered body.
A method of melting, at a high temperature, a powder containing silicon (for example, a powder made of a silicon oxide, silica sand, or silica gel) and a powder containing a specific element (for example, a powder of an oxide of a specific element, a carbonate, a sulfate, a nitrate, an oxalate, or a hydroxide), and then cooling and solidifying the melted powders to provide a melt.

Specific examples of the vapor deposition method with the vapor deposition material include a vacuum vapor deposition method. The vacuum vapor deposition method is a method of evaporating a vapor deposition material in a vacuum chamber and adhering to a surface of a substrate.

The temperature (for example, the temperature of the boat on which the vapor deposition material is disposed when a vacuum vapor deposition apparatus is used) during vapor deposition is preferably from 100 to 3,000° C., and more preferably from 500 to 3,000° C.

The pressure (for example, the pressure in a tank in which the vapor deposition material is disposed when a vacuum vapor deposition apparatus is used) during vapor deposition is preferably 1 Pa or less, and more preferably 0.1 Pa or less.

When the underlayer is formed with the vapor deposition material, one vapor deposition material may be used, or two or more kinds of vapor deposition materials containing different elements may be used.

Specific examples of the evaporation method of the vapor deposition material include a resistance heating method of melting and evaporating the vapor deposition material on a resistance heating boat made of a high melting point metal, and an electron gun method of irradiating the vapor deposition material with an electron beam and directly heating the vapor deposition material to melt the surface and evaporate the vapor deposition material. As a method of evaporating the vapor deposition material, the electron gun method is preferable from the viewpoint that a high melting point substance can be locally heated and thus can also be evaporated, and from the viewpoint that there is no possibility of reaction with a container or mixing of impurities because a portion that is not hit by an electron beam is at a low temperature.

As the evaporation method of a vapor deposition material, a plurality of boats may be used, or all vapor deposition materials may be placed in a single boat and used. The vapor deposition method may be co-vapor deposition, alternate vapor deposition, or the like. Specific examples thereof include an example in which silica and a specific source are mixed in the same boat and used, an example in which silica and a specific element source are placed in separate boats and co-deposited, and an example in which silica and a specific element source are placed in separate boats and alternately deposited. Conditions, order, and the like of vapor deposition are appropriately selected depending on the configuration of the underlayer.

In the wet coating method, it is preferable to form an underlayer on a substrate by a wet coating method with a coating liquid containing a compound containing silicon, a compound containing a specific element, and a liquid medium.

Specific examples of the silicon compound include silicon oxide, silicic acid, and partial condensates of silicic acid, alkoxysilane, and partial hydrolysis condensates of alkoxysilane.

Specific examples of the compound containing a specific element include an oxide of the specific element, an alkoxide of the specific element, a carbonate of the specific element, a sulfate of the specific element, a nitrate of the specific element, an oxalate of the specific element, and a hydroxide of the specific element.

Examples of the liquid medium include those same the liquid medium contained in the composition of the present disclosure.

The content rate of the liquid medium is preferably from 0.01 to 20% by mass, and more preferably from 0.1 to 10% by mass with respect to the total amount of the coating liquid used for forming the underlayer.

Specific examples of the wet coating method of forming the underlayer include a spin coating method, a wipe coating method, a spray coating method, a squeegee coating method, a dip coating method, a die coating method, an inkjet method, a flow coating method, a roll coating method, a casting method, a Langmuir-Blodgett method, and a gravure coating method.

It is preferable to wet coat the coating liquid and then dry the coating film. The drying temperature of the coating film is preferably from 20 to 200° C., and more preferably from 80 to 160° C.

The article of the present disclosure is preferably an optical member. Examples of the optical member include a car navigation, a mobile phone, a smartphone, a digital camera, a digital video camera, a PDA, a portable audio player, a car audio, a game machine, a spectacle lens, a camera lens, a lens filter, sunglasses, a medical instrument such as a stomach camera, a copying machine, a PC, a display (for example, a liquid crystal display, an organic EL display, a plasma display, or a touch panel display), a touch panel, a protective film, and an antireflection film. In particular, the article is preferably a display or a touch panel.

### [Method of Producing Article]

The method of producing an article of the present disclosure is, for example, a method of producing an article in which a surface treatment layer is formed on a substrate by performing a surface treatment on the substrate with the surface treatment agent of the present disclosure. Examples of the surface treatment include a dry coating method and a wet coating method.

Examples of the dry coating method include methods such as vacuum vapor deposition, CVD, and sputtering. As the dry coating method, a vacuum vapor deposition method is preferable from the viewpoint of suppressing decomposition of the compound and convenience of the apparatus. At the time of vacuum vapor deposition, a pellet-shape substance may be used which is obtained by impregnating a metal porous body of iron, steel, or the like with the compound of the present disclosure. A pellet-shaped substance may be used which is impregnated with the compound of the present disclosure by impregnating a metal porous body such as iron or steel with a composition containing the compound of the present disclosure and a liquid medium and drying the liquid medium.

Examples of the wet coating method include a spin coating method, a wipe coating method, a spray coating method, a squeegee coating method, a dip coating method, a die coating method, an inkjet method, a flow coating method, a roll coating method, a casting method, a Langmuir-Blodgett method, and a gravure coating method.

In order to improve the abrasion resistance of the surface treatment layer, an operation for promoting the reaction between the compound of the present disclosure and the substrate may be performed as necessary. Examples of the operation include heating, humidification, and light irradiation.

For example, the substrate on which the surface treatment layer is formed can be heated in the atmosphere having moisture to promote reactions such as a hydrolysis reaction of a hydrolyzable group, a reaction between a hydroxyl group or the like on the surface of the substrate and a silanol group, and generation of a siloxane bond by a condensation reaction of a silanol group.

After the surface treatment, the compound in the surface treatment layer, which is not chemically bonded to another compound or the substrate, may be removed as necessary. Examples of the removal method include a method of pouring a solvent on the surface treatment layer and a method of wiping the surface treatment layer with a cloth soaked with the solvent.

### EXAMPLES

Hereinafter, the present invention will be described in more detail with reference to Examples, but the present invention is not limited to these Examples.

### [Synthesis of Compound 1C]

22-Tricosenoic acid (2.0 g), heptamethylcyclotetrasiloxane (1.7 g, manufactured by Gelest, Inc.) and 1,3-bistrifluoromethylbenzene (10 g) were added and stirred, and then a toluene solution of platinum/1,3-divinyl-1,1,3,3-tetramethyldisiloxane complex (platinum content rate 3%, 0.1 g) and aniline (0.1 g) were added thereto and stirred at 85° C. for 24 hours. After cooling to 25° C., the solvent was distilled off, and flash column chromatography (developing solvent: ethyl acetate/hexane) with silica gel was performed to provide 3.0 g of a Compound 1A. The structure of the Compound 1A was confirmed from the following NMR data.

¹H-NMR (500 MHz, Chloroform-d) δ 2.31 (t, J=7.1 Hz, 2H), 1.60 (p, J=7.1 Hz, 2H), 1.41-1.14 (m, 38H), 0.70 (t, J=7.0 Hz, 2H), 0.20-0.14 (m, 21H)

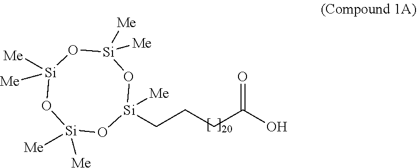 [SMILES: C[Si]1(C)O[Si](C)(C)O[Si](C)(CCCC(=O)O)O[Si](C)(C)O1]

Allyl alcohol (30 g) was added to the Compound 1A (3.0 g) and stirred, and then N-methylmorpholine (1.0 g) and 4-(4,6-dimethoxy-1,3,5-triazine-2-yl)-4-methylmorpholinium chloride (3.0 g) were added thereto. The temperature was raised to 50° C., and heating and stirring were performed overnight. After cooling to 25° C., flash column chromatography (developing solvent: ethyl acetate/hexane) with silica gel was performed to provide 2.0 g of a Compound 1B. The structure of the Compound 1B was confirmed from the following NMR data.

¹H-NMR (500 MHz, Chloroform-d) δ 6.03-5.84 (m, 1H), 5.31 (dt, J=13.4, 1.0 Hz, 2H), 4.57 (dt, J=6.2, 1.0 Hz, 2H), 1.71-1.51 (m, 4H), 1.45-1.16 (m, 38H), 0.70 (t, J=7.0 Hz, 2H), 0.19-0.23 (m, 21H)

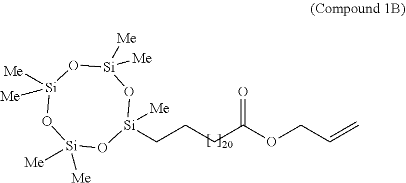 [SMILES: C=CCOC(=O)CCC[Si]1(C)O[Si](C)(C)O[Si](C)(C)O[Si](C)(C)O1]

1,3-Bistrifluoromethylbenzene (10 g) was added to the Compound 1B (2.0 g) and stirred. Thereafter, a toluene solution (platinum content rate 3%, 0.1 g) of platinum/1,3-divinyl-1,1,3,3-tetramethyldisiloxane complex, aniline (0.1 g), and trimethoxysilane (0.5 g) were added and stirred at 40° C. for 24 hours. The solvent was distilled off under reduced pressure to provide 2.3 g of a Compound 1C. The structure of the Compound 1C was confirmed from the following NMR data.

¹H-NMR (500 MHz, Chloroform-d) δ 4.09 (t, J=7.1 Hz, 2H), 2.31 (t, J=7.1 Hz, 2H), 1.80 (p, J=7.1 Hz, 2H), 1.58 (p, J=7.1 Hz, 2H), 1.42-1.09 (m, 38H), 0.68 (dt, J=18.7, 7.0 Hz, 4H), 0.23-0.16 (m, 21H)

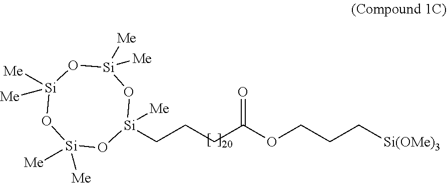

### [Synthesis of Compound 2C]

The following Compound 2A was obtained according to the method described in Synthesis Examples 3 to 5 of WO 2021/054413.

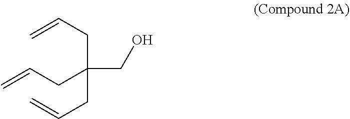

The Compound 1A (3.0 g) was added to the Compound 2A(5.0 g) and stirred, and then N-methylmorpholine (1.0 g) and 4-(4,6-dimethoxy-1,3,5-triazine-2-yl)-4-methylmorpholinium chloride (3.0 g) were added thereto. The temperature was raised to 50° C., and stirring was performed for 24 hours. After cooling to 25° C., flash column chromatography (developing solvent: ethyl acetate/hexane) with silica gel was performed to provide 2.8 g of a Compound 2B. The structure of the Compound 2B was confirmed from the following NMR data.

¹H-NMR (500 MHz, Chloroform-d) δ 5.66 (ddt, J=13.6, 12.6, 6.2 Hz, 3H), 5.13 (dt, J=13.5, 1.1 Hz, 6H), 3.98 (s, 2H), 2.37 (t, J=7.1 Hz, 2H), 1.91 (dt, J=6.2, 1.0 Hz, 6H), 1.58 (p, J=7.1 Hz, 2H), 1.41-1.16 (m, 38H), 0.70 (t, J=7.0 Hz, 2H), 0.19-0.21 (m, 21H)

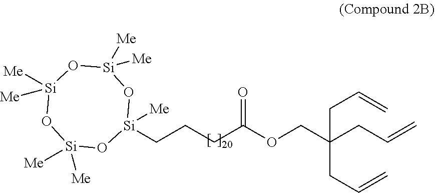 [SMILES: C=CCC(CC=C)(CC=C)COC(=O)CCC[Si]1(C)O[Si](C)(C)O[Si](C)(C)O[Si](C)(C)O1]

1,3-Bistrifluoromethylbenzene (10 g) was added to the Compound 2B (2.8 g) and stirred. Thereafter, a toluene solution (platinum content rate 3%, 0.1 g) of platinum/1,3-divinyl-1,1,3,3-tetramethyldisiloxane complex, aniline (0.1 g), and trimethoxysilane (1.5 g) were added and stirred at 40° C. for 24 hours. The solvent was distilled off under reduced pressure to provide 3.5 g of a Compound 2C. The structure of the Compound 2C was confirmed from the following NMR data.

¹H-NMR (500 MHz, Chloroform-d) δ 4.02 (s, 2H), 3.58 (s, 27H), 2.37 (t, J=7.1 Hz, 2H), 1.58 (p, J=7.1 Hz, 2H), 1.48-1.18 (m, 50H), 0.69 (td, J=7.0, 3.1 Hz, 8H), 0.20-0.21 (m, 21H).

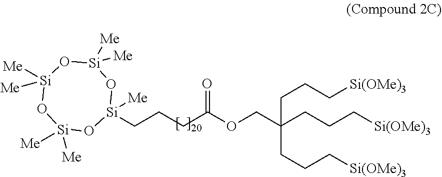

### [Synthesis of Compound 3F]

Polyethylene glycol (8.0 g) having an average molecular weight of 400 was dissolved in THE (20 mL), cesium carbonate (8.0 g), and allyl bromide (2.4 g) were added and stirred at 50° C. for 24 hours. Thereafter, the solvent was distilled off, and flash column chromatography (developing solvent: methanol/dichloromethane) using silica gel was performed to provide 3.1 g of a Compound 3A. The structure of the Compound 3A was confirmed from the following NMR data.

¹H-NMR (500 MHz, Chloroform-d) δ 5.85 (tt, J=13.7, 6.2 Hz, 1H), 5.22 (dt, J=13.5, 1.1 Hz, 2H), 4.02-3.80 (m, 4H), 3.80-3.46 (m, 34H)

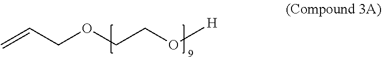

Heptamethylcyclotetrasiloxane (2.3 g, manufactured by Gelest, Inc.) and 1,3-bistrifluoromethylbenzene (20 g) were added to the Compound 3A (3.1 g), and stirred. Thereafter, a toluene solution (platinum content rate 3%, 0.1 g) of platinum/1,3-divinyl-1,1,3,3-tetramethyldisiloxane complex and aniline (0.1 g) were added, and stirred at 85° C. for 24 hours. After cooling to 25° C., flash column chromatography (developing solvent: ethyl acetate/hexane) with silica gel was performed to provide 4.0 g of a Compound 3B. The structure of the Compound 3B was confirmed from the following NMR data.

¹H-NMR (500 MHz, Chloroform-d) δ 3.82-3.30 (m, 38H), 1.62 (p, J=7.1 Hz, 2H), 0.77 (t, J=7.1 Hz, 2H), 0.16-0.18 (m, 21H)

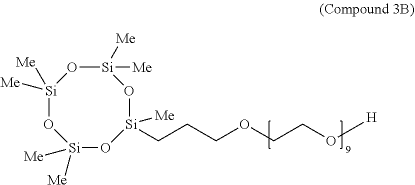

The Compound 3C was obtained according to the method described in Synthesis Examples 3 and 4 of WO 2021/054413.

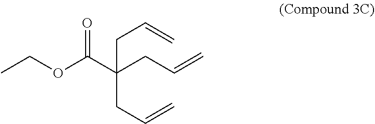

Methanol (50 g) and potassium hydroxide (5 g) were added to the Compound 3C (10 g), and heating and refluxing were performed overnight. After cooling to 25° C., hydrochloric acid and dichloromethane were added to perform extraction, the solvent was distilled off, and flash column chromatography (developing solvent: methanol/dichloromethane) using silica gel was then performed to provide 8.3 g of a Compound 3D. The structure of the Compound 3D was confirmed from the following NMR data.

¹H-NMR (500 MHz, Chloroform-d) δ 5.71 (ddt, J=13.7, 12.6, 6.2 Hz, 3H), 5.16 (dt, J=13.4, 1.1 Hz, 6H), 2.20 (dt, J=6.2, 0.9 Hz, 6H)

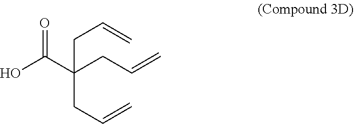

The Compound 3D (1.5 g) and THE (10 mL) were added to the Compound 3B (4.0 g) and stirred, and then N-methylmorpholine (1.0 g) and 4-(4,6-dimethoxy-1,3,5-triazine-2-yl)-4-methylmorpholinium chloride (3.0 g) were added thereto.

The temperature was raised to 50° C., and stirring was performed at 50° C. for 24 hours. After cooling to 25° C., flash column chromatography (developing solvent: ethyl acetate/hexane) with silica gel was performed to provide 3.8 g of a Compound 3E. The structure of the Compound 3E was confirmed from the following NMR data.

¹H-NMR (500 MHz, Chloroform-d) δ 5.71 (ddt, J=13.6, 12.6, 6.2 Hz, 3H), 5.16 (dt, J=13.4, 1.1 Hz, 6H), 4.36 (t, J=7.0 Hz, 2H), 3.85-3.26 (m, 36H), 2.22 (dt, J=6.2, 1.0 Hz, 6H), 1.62 (p, J=7.1 Hz, 2H), 0.77 (t, J=7.1 Hz, 2H), 0.20-0.27 (m, 21H).

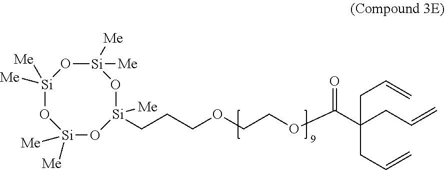

1,3-Bistrifluoromethylbenzene (10 g) was added to the Compound 3E (3.0 g) and stirred. Thereafter, a toluene solution (platinum content rate 3%, 0.1 g) of platinum/1,3-divinyl-1,1,3,3-tetramethyldisiloxane complex, aniline (0.1 g), and trimethoxysilane (1.5 g) were added thereto and stirred at 40° C. for 24 hours, and then the solvent was distilled off under reduced pressure to provide 3.5 g of a Compound 3F. The structure of the Compound 3F was confirmed from the following NMR data.

¹H-NMR (500 MHz, Chloroform-d) δ 4.36 (t, J=7.0 Hz, 2H), 3.87-3.29 (m, 63H), 1.74-1.40 (m, 14H), 0.74 (dt, J=22.3, 7.1 Hz, 8H), 0.19-0.18 (m, 21H).

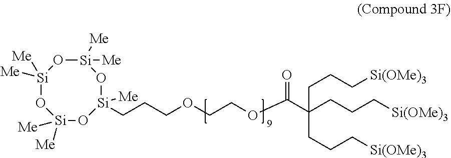

### [Synthesis of Compound 4D]

Allylamine (10 g) and 1,3-bistrifluoromethylbenzene (10 g) were added to α-monovinyl-Ω-monohydride-terminated polydimethylsiloxane (10 g, product number: DMS-HV15, manufactured by Gelest, Inc.) having an average molecular weight of about 2,500, and stirred. Thereafter, a toluene solution (platinum content rate 3%, 0.1 g) of platinum/1,3-divinyl-1, 1,3,3-tetramethyldisiloxane complex and aniline (0.1 g) were added, and heated and stirred at 100° C. for 24 hours. After cooling to 25° C., flash column chromatography (developing solvent: methanol/dichloromethane) using silica gel was performed to provide 6.8 g of a Compound 4A. The structure of the Compound 4A was confirmed from the following NMR data. In the Compound 4A, the average value of n was 32.

¹H-NMR (500 MHz, Chloroform-d) δ 6.05 (ddt, J=18.7, 16.8, 1.2 Hz, 1H), 5.81 (ddd, J=45.1, 17.8, 1.8 Hz, 2H), 2.66 (p, J=6.8 Hz, 2H), 1.48 (p, J=7.1 Hz, 2H), 0.75 (t, J=7.1 Hz, 2H), 0.31-0.16 (m, 198H)

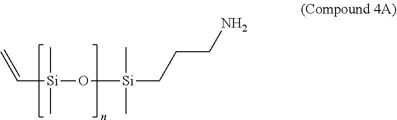

Heptamethylcyclotetrasiloxane (1.2 g, manufactured by Gelest, Inc.) and 1,3-bistrifluoromethylbenzene (20 g) were added to the Compound 4A, and stirred. Thereafter, a toluene solution (platinum content rate 3%, 0.1 g) of platinum/1,3-divinyl-1,1,3,3-tetramethyldisiloxane complex and aniline (0.1 g) were added, and stirred at 85° C. for 24 hours. After cooling to 25° C., the solvent was distilled off, and flash column chromatography (developing solvent: methanol/dichloromethane) using silica gel was performed to provide 5.3 g of a Compound 4B. The structure of the Compound 4B was confirmed from the following NMR data. In the Compound 4B, the average value of n was 32.

¹H-NMR (500 MHz, Chloroform-d) δ 2.66 (p, J=6.8 Hz, 2H), 1.48 (p, J=7.1 Hz, 2H), 0.87-0.65 (m, 6H), 0.17-0.10 (m, 219H)

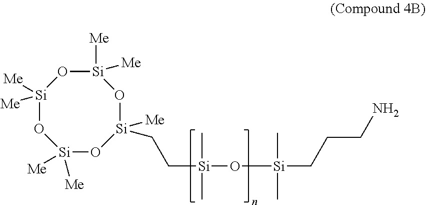

The Compound 3D (1.5 g) and THE (10 mL) were added to the Compound 4B (5.3 g) and stirred, and then N-methylmorpholine (1.0 g) and 4-(4,6-dimethoxy-1,3,5-triazine-2-yl)-4-methylmorpholinium chloride (3.0 g) were added thereto. Stirring was performed at 50° C. for 24 hours. After cooling to 25° C., flash column chromatography (developing solvent: ethyl acetate/hexane) with silica gel was performed to provide 4.3 g of a Compound 4C. The structure of the Compound 4C was confirmed from the following NMR data. In the Compound 4C, the average value of n was 32.

¹H-NMR (500 MHz, Chloroform-d) δ 5.78-5.55 (m, 3H), 5.16 (dt, J=13.4, 1.1 Hz, 6H), 3.08 (q, J=7.0 Hz, 2H), 2.13 (dt, J=6.2, 1.1 Hz, 6H), 1.57 (p, J=7.1 Hz, 2H), 0.86-0.66 (m, 6H), 0.21-0.14 (m, 219H)

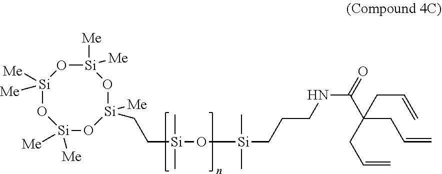

1,3-Bistrifluoromethylbenzene (10 g) was added to the Compound 4C (4.3 g) and stirred. Thereafter, a toluene solution (platinum content rate 3%, 0.1 g) of platinum/1,3-divinyl-1,1,3,3-tetramethyldisiloxane complex, aniline (0.1 g), and trimethoxysilane (1.0 g) were added thereto and stirred at 40° C. for 24 hours, and then the solvent was distilled off under reduced pressure to provide 4.9 g of a Compound 4D. The structure of the Compound 4D was confirmed from the following NMR data. In the Compound 4D, the average value of n was 32.

¹H-NMR (500 MHz, Chloroform-d) δ 3.58 (s, 27H), 3.08 (q, J=6.9 Hz, 2H), 1.70-1.36 (m, 14H), 0.88-0.57 (m, 12H), 0.27-0.16 (m, 219H)

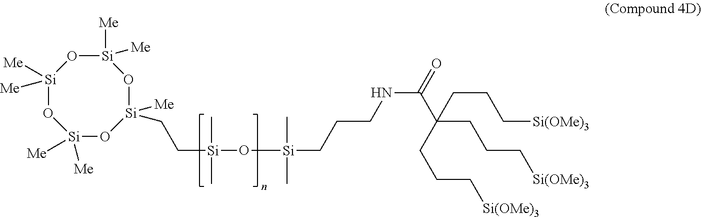

### [Synthesis of Compound 5C]

Allylamine (1.0 g) and 1,3-bistrifluoromethylbenzene (10 g) were added to monodispersed hydride-terminated polydimethylsiloxane (60 g, product number: DMS-Hm15, manufactured by Gelest, Inc.) having an average molecular weight of about 3,000, and stirred. Thereafter, a toluene solution (platinum content rate 3%, 0.1 g) of platinum/1,3-divinyl-1,1,3,3-tetramethyldisiloxane complex and aniline (0.1 g) were added, and stirred at 100° C. for 4 hours. Subsequently, allyl-substituted poly (isobutyl-T8-silsesquioxane) (20 g, product number: SST-A8C42, manufactured by Gelest, Inc.) was added thereto, and further stirred at 100° C. for 4 hours. After cooling to 25° C., flash column chromatography (developing solvent: methanol/dichloromethane) using silica gel was performed to provide 21 g of a Compound 5A. The structure of the Compound 5A was confirmed from the following NMR data. In the Compound 5A, the average value of n was 40.

¹H-NMR (500 MHz, Chloroform-d) δ 2.73 (t, J=7.1 Hz, 2H), 1.85 (dpd, J=13.7, 6.9, 3.1 Hz, 7H), 1.62 (p, J=7.1 Hz, 2H), 1.21 (p, J=7.1 Hz, 2H), 1.03-0.86 (m, 42H), 0.63-0.06 (m, 266H)

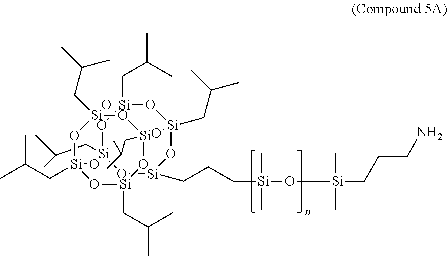

The Compound 3D (1.5 g) and THE (10 mL) were added to the Compound 5A(5.0 g) and stirred, and then N-methylmorpholine (1.0 g) and 4-(4,6-dimethoxy-1,3,5-triazine-2-yl)-4-methylmorpholinium chloride (3.0 g) were added thereto. Stirring was performed at 50° C. for 24 hours. After cooling to 25° C., flash column chromatography (developing solvent: ethyl acetate/hexane) with silica gel was performed to provide 4.0 g of a Compound 5B. The structure of the Compound 5B was confirmed from the following NMR data. In the Compound 5B, the average value of n was 40.

¹H-NMR (500 MHz, Chloroform-d) δ 5.74 (tt, J=13.4, 6.2 Hz, 3H), 5.04 (dt, J=13.5, 1.0 Hz, 6H), 3.33 (t, J=7.1 Hz, 2H), 2.12 (dddt, J=120.7, 12.3, 6.2, 1.0 Hz, 6H), 1.85 (dpd, J=13.7, 6.9, 3.1 Hz, 7H), 1.62 (p, J=7.1 Hz, 2H), 1.21 (p, J=7.1 Hz, 2H), 1.05-0.85 (m, 42H), 0.67-0.00 (m, 266H)

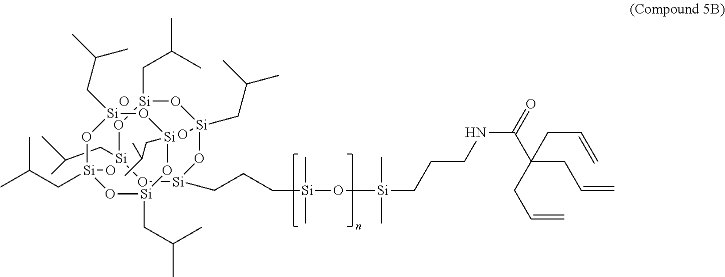

1,3-Bistrifluoromethylbenzene (10 g) was added to the Compound 5B (4.0 g) and stirred, and then a toluene solution of platinum/1,3-divinyl-1,1,3,3-tetramethyldisiloxane complex (platinum content rate 3%, 0.1 g), aniline (0.1 g), and trimethoxysilane (1.0 g) were added thereto and stirred at 40° C. for 24 hours, and then the solvent was distilled off under reduced pressure to provide 4.3 g of a Compound 5C. The structure of the Compound 5C was confirmed from the following NMR data. In the Compound 5C, the average value of n was 40.

¹H-NMR (500 MHz, Chloroform-d) δ 3.58 (s, 27H), 3.33 (t, J=7.1 Hz, 2H), 1.85 (dpd, J=13.7, 6.9, 3.1 Hz, 7H), 1.71-1.04 (m, 16H), 1.02-0.85 (m, 42H), 0.61-0.02 (m, 272H)

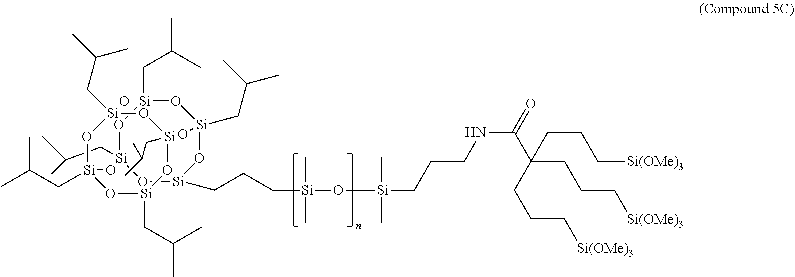

### [Synthesis of Compound 6A]

A Compound 6A was obtained according to the method described in Example 1 of JP-A 2017-119849.

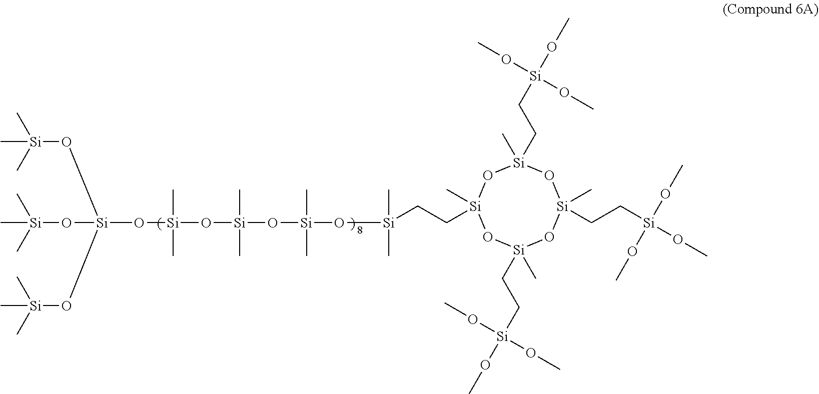

### [Preparation of Compound 7A]

Octadecyltrimethoxysilane (manufactured by Tokyo Chemical Industry Co., Ltd.) was prepared as the Compound 7A.

Then, the substrate was subjected to a surface treatment using the Compounds 1C, 2C, 3F, 4D, 5C, 6A, and 7A. As a surface treatment method, a dry coating method was used. As the substrate, chemically strengthened glass was used.

### <Dry Coating Method>

The dry coating was performed using a vacuum vapor deposition apparatus (product name “VTR-350M”, manufactured by ULVAC, Inc.). A 20% by mass ethyl acetate solution (0.5 g) of each Compound was filled in a molybdenum boat in a vacuum vapor deposition apparatus, and the inside of the vacuum vapor deposition apparatus was evacuated so that the pressure thereof was 1×10⁻³ Pa or less. The boat was heated at a temperature increase rate of 10° C./min or less, and when the vapor deposition rate by the quartz crystal microbalance exceeded 1 nm/sec, the shutter was opened to start film formation on the surface of the substrate. When the film thickness reached about 50 nm, the shutter was closed to finish the film formation on the surface of the substrate. The substrate on which the compound was deposited was heat-treated at 150° C. for 30 minutes to provide an article having a surface treatment layer on the surface of the substrate.

The article obtained by the dry coating method was evaluated for water repellency and abrasion resistance. The evaluation method is as follows.

### <Water Repellency>

About 2 μL of distilled water was dropped on the surface treatment layer of the article, and the initial water contact angle was measured using a contact angle measuring apparatus (product name “DM-500”, manufactured by Kyowa Interface Science Co., Ltd.). The measurement was performed at five locations on the surface treatment layer, and the average value was calculated. The water contact angle was calculated by the 20 method. The evaluation method is as follows. A is a level at which there is no problem in practical use.
A: water contact angle is 110° or more.
B: water contact angle is 108° or more and less than 110°.
C: water contact angle is less than 108°.

### <Abrasion Resistance>

In accordance with JIS L0849:2013 (corresponding ISO: 105-X12:2001), a steel wool bonster (#0000) was reciprocated 10,000 times at a pressure of 98.07 kPa and a speed of 320 cm/min with a reciprocating traverse tester (manufactured by KNT Co., Ltd.), and then the water contact angle after the friction test was measured for the surface treatment layer of the article. The method of measuring the water contact angle after the friction test is the same as the initial method of measuring the water contact angle in the method of evaluating water repellency. The abrasion resistance was evaluated based on the degree of reduction in the water contact angle by the friction test. It can be said that as the reduction degree of the water contact angle decreases, the abrasion resistance is more excellent. The evaluation method is as follows. A and B are levels at which there is no problem in practical use.

Reduction degree of water contact angle=(initial water contact angle)−(water contact angle after friction test)
A: degree of decrease in water contact angle was 5° or less.
B: degree of decrease in water contact angle was more than 5° and 10° or less.
C: degree of decrease in water contact angle was more than 10°.

The evaluation results are shown in Table 1. In Table 1, in a case in which the compound contains the Group 1, the type of the Group 1 is described, and in a case in which the compound do not contain the Group 1, the compound is described as “−”. In a case in which the compound contains a partial structure that is an alkylene chain, a polyalkylene oxide chain, a divalent organopolysiloxane residue, or a combination thereof, the type of the partial structure is described. In a case in which the compound contained the Group 2, it was described as “Y”

Examples 1 to 5 is an example, and Examples 6 and 7 are comparative examples.

TABLE 1

| | | | | | Evaluation | |
|---|---|---|---|---|---|---|
| | Compound | | | | Water | Abrasion |
| | Type | Group 1 | Partial structure | Group 2 | repellency | resistance |
| Example 1 | Compound 1C | Cyclic | Alkylene chain | Y | A | B |
| | | polysiloxane | | | | |
| | | residue | | | | |
| Example 2 | Compound 2C | Cyclic | Alkylene chain | Y | A | A |
| | | polysiloxane | | | | |
| | | residue | | | | |
| Example 3 | Compound 3F | Cyclic | Polyalkylene | Y | A | B |
| | | polysiloxane | oxide chain | | | |
| | | residue | | | | |
| Example 4 | Compound 4D | Cyclic | Alkylene | Y | A | B |
| | | polysiloxane | chain/divalent | | | |
| | | residue | polysiloxane | | | |
| | | | residue/alkylene | | | |
| | | | chain | | | |
| Example 5 | Compound 5C | Cage-like | Alkylene | Y | A | A |
| | | polysiloxane | chain/divalent | | | |
| | | residue | polysiloxane | | | |
| | | | residue/alkylene | | | |
| | | | chain | | | |
| Example 6 | Compound 6A | — | Divalent | Y | B | C |
| | | | polysiloxane | | | |
| | | | residue/alkylene | | | |
| | | | chain | | | |
| Example 7 | Compound 7A | — | Alkylene chain | Y | C | B |

As shown in Table 1, the compounds of Examples 1 to 5 contain the Group 1, a partial structure that is an alkylene chain, a polyalkylene oxide chain, a divalent organopolysiloxane residue, or a combination thereof, and the Group 2, and thus it was found that a surface treatment layer excellent in water repellency and abrasion resistance can be formed.

On the other hand, the compound of Example 6 did not contain the Group 1, and was found to be poor in abrasion resistance. The compound of Example 7 did not contain the Group 1, and was found to be poor in water repellency.

### INDUSTRIAL APPLICABILITY

The compound of the present disclosure is useful as a surface treatment agent. The surface treatment agent can be used, for example, for a substrate in a display device such as a touch panel display, an optical element, a semiconductor element, a building material, an automobile component, a nanoimprint technology, or the like. In addition, the surface treatment agent can be used for a body, a window glass (windshield, side glass, rear glass), a mirror, a bumper, and the like in transportation equipment such as a train, an automobile, a ship, and an airplane. Further, the surface treatment agent can be used for outdoor articles such as a building outer wall, a tent, a solar power generation module, a sound insulating plate, or concrete; a fishing net, an insect trap net, and a water tank. In addition, the surface treatment agent is used for a kitchen, a bathroom, a wash basin, a mirror, and a toilet peripheral component; chinaware such as a chandelier and a tile; various indoor facilities such as artificial marble and an air conditioner. In addition, the surface treatment agent can be used as an antifouling treatment for jigs, inner walls, pipes, and the like in a factory. In addition, the surface treatment agent can be used for goggles, glasses, helmets, pachinko, fibers, umbrellas, playing tools, and soccer balls. In addition, the surface treatment agent can be used as an adhesion inhibitor for various packaging materials such as food packaging materials, cosmetic packaging materials, and the inside of a pot. In addition, the surface treatment agent can be used for optical members such as a car navigation, a mobile phone, a smartphone, a digital camera, a digital video camera, a PDA, a portable audio player, a car audio, a game machine, a spectacle lens, a camera lens, a lens filter, sunglasses, and a medical instrument such as a stomach camera, a copying machine, a PC, a display (for example, a liquid crystal display, an organic EL display, a plasma display, or a touch panel display), a touch panel, a protective film, and an antireflection film.

The disclosure of Japanese Patent Application No. 2022-049061 filed on Mar. 24, 2022 is incorporated herein by reference in its entirety. Furthermore, all documents, patent applications, and technical standards described in this specification are incorporated herein by reference to the same extent as if each individual document, patent application, and technical standard were specifically and individually described to be incorporated by reference.

1. A compound comprising: the following Group 1; a partial structure that is an alkylene chain, a polyalkylene oxide chain, a divalent organopolysiloxane residue, or a combination thereof, and the following Group 2:
Group 1: monovalent cyclic polysiloxane residue or monovalent cage-like polysiloxane residue
Group 2: —Si(R²)ₙL₃₋ₙ
wherein, in Group 2, R² represents a monovalent hydrocarbon group, each L independently represents a hydrolyzable group or a hydroxyl group, and n represents an integer from 0 to 2.

2. The compound according to claim 1, the compound being represented by the following Formula 1:
[T-(O)ᵣ—Z]_{q}A(S(R²)ₙL₃₋ₙ)ₚ (1)
wherein, in Formula 1, T represents a monovalent cyclic polysiloxane residue or a monovalent cage-like polysiloxane residue, r represents 0 or 1, Z represents an alkylene chain, a polyalkylene oxide chain, a divalent organopolysiloxane residue, or a combination thereof, A represents a single bond or a (p+q)-valent linking group, each R² independently represents a monovalent hydrocarbon group, each L independently represents a hydrolyzable group or a hydroxyl group, n represents an integer from 0 to 2, and each of p and q independently represents an integer of 1 or more.

3. The compound according to claim 2, wherein Z is an alkylene chain having 12 or more carbon atoms in the Formula 1.

4. The compound according to claim 2, wherein, in the Formula 1, Z is represented by —Z¹—Z²—Z³—, each of Z¹ and Z³ is independently an alkylene chain, and Z² is a divalent organopolysiloxane residue.

5. The compound according to claim 2, wherein, in the Formula 1, T is represented by the following Formula T1: 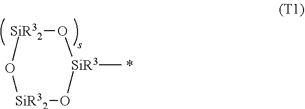
wherein, in Formula T1, each R³ independently represents a hydrocarbon group, a hydrocarbon group having a substituent, or a group represented by —O—SiR⁵¹₃, s represents an integer from 1 to 4, and each R⁵¹ independently represents a hydrocarbon group or a trialkylsilyloxy group.

6. The compound according to claim 5, wherein, in the Formula T1, each R³ independently represents an alkyl group having from 1 to 4 carbon atoms.

7. A composition, comprising the compound according to claim 1 and a liquid medium.

8. A surface treatment agent, comprising the compound according to claim 1.

9. A surface treatment agent, comprising the compound according to claim 1 and a liquid medium.

10. A method of producing an article, the method comprising subjecting a substrate to a surface treatment with the surface treatment agent according to claim 8 to produce an article having a surface treatment layer formed on the substrate.

11. An article, comprising: a substrate; and a surface treatment layer disposed on the substrate and surface-treated with the surface treatment agent according to claim 8.

12. The article according to claim 11, the article being an optical member.

13. The article according to claim 11, the article being a display or a touch panel.
